(19) United States
(12) Patent Application Publication
(10) Pub. No.: US 2003/0200533 A1
(43) Pub. Date: Oct. 23, 2003

(54) Method and apparatus for creating software objects

(76) Inventors: Andrew F. Roberts, Melrose, MA (US); Jonathan Booth, Portsmouth, NH (US); Stephen Zagieboylo, Durham, NH (US)

Correspondence Address: COUDERT BROTHERS LLP, 333 SOUTH HOPE STREET, 23RD FLOOR, LOS ANGELES, CA, 90071, US

(21) Appl. No.: 10/307,239

(22) Filed: Nov. 27, 2002

Related U.S. Application Data
(60) Provisional application No. 60/334,207, filed on Nov. 28, 2001.

(51) Int. Cl. G06F 9/44

(52) U.S. Cl. 717/124

(57) ABSTRACT

The invention provides a method and apparatus for the dynamic generation and regeneration of software objects that can have logic that specifies structure, functionality and behavior in a computing system. One embodiment is the regeneration function that produces related, but different instances of software objects, including System Logic Objects. The regeneration function comprises ordered sequences of tasks, whose definition, and parameterization are obtained from a Generative Model, and which are performed by software objects called Builders. Each Builder accepts a set of input parameters and a reference to a container that contains zero or more generated software objects, including System Logic Objects. The regeneration function directs each Builder to work on the contents of the container, add, modify, and delete objects, and return the container with updated contents. The behavior of the regeneration function can be altered by disabling selected Builders, and by changing the inputs to the Builders.

This application claims the benefit of priority from U.S. Provisional Application titled “Method and Apparatus for Creating System Logic,” Serial No. 60/334,207, filed Nov. 28, 2001.

### BACKGROUND OF THE INVENTION

1. Field of the Invention

The present invention relates in general to computer software, and in particular to a software system that dynamically creates objects used by computing systems. More specifically, but without restriction to the particular embodiments hereinafter described in accordance with the best mode of practice, this invention relates to a method and system for dynamically creating source objects that represent embodiments of logic used in computing systems. These embodiments of logic are referred to as System Logic Objects.

2. Background Art

In the past, people have provided tools that assist programmers in the creation of the source objects that define the structure, functionality, and behavior of programs on computing systems. Examples of source objects include files written in compiled languages such as Java and C, as well as files written in interpreted languages such as XML and Javascript.

The tools for creating and modifying source objects have focused on making programmers more efficient in their jobs. Some approaches have focused on providing high-level source code languages with keywords that carry lots of meaning, and, thus, reduce the amount of source code that needs to be written, while other approaches have focused on providing tools in the form of “wizards” and “macros” that assist the programmer in the task of writing large amounts of low-level source code.

Tools that assist authors in the creation of objects, through direct manipulation of object entities, are known as “explicit” authoring tools. Such tools provide the author with direct manipulation access to the source object in the form of text, graphical manipulation, and other interaction means. These tools enable the author to directly create, delete, and modify elements of the source objects. A word processor is an example of an explicit tool for creating document text, whereas the popular “vi” and “emacs” editors are examples of explicit tools for creating the source objects for computer programs.

When a user wants to make a change to an object, using an “explicit” authoring tool, he or she will open the object in the appropriate editing environment, make the change or changes through direct manipulation of the object's entities, and save the updated object. Such systems provide the user with direct access to the contents of the objects, and provide tools for adding, removing and modifying entities directly in these objects. Examples of such approaches include 1) text-based and graphical-based programming tools for creating programs in compiled languages such as Cobol, Java, C++, and C#, 2) text-based and graphical-based approaches for creating declarative documents in languages such as IBM's Web Service Flow language (WSFL), and Microsoft's XLANG language, and 3) text-based and graphical-based approaches for creating sets of declarative rules used in rules engines, including inference engines employing the “forward and backward chaining” Rete algorithm.

Historically, computer programmers have relied upon the use of explicit editing tools to create and maintain the source objects that represent computer programs. Even as programming languages have evolved over the years from low-level compiled languages such as C, to high-level interpreted languages such as HTML and XML, the use of explicit tools has continued. Furthermore, even with the emergence of powerful graphical “drag and drop” tools, and fancy wizards and macros, the explicit nature of these tools has not changed. Users still end up manipulating entities directly in the source objects, be it by graphical gesture, typed-in gesture, or with the help of a wizard or macro. In the end, a source object is created and modified explicitly by the user. There are a number of limitations in approaches to creating source objects using “explicit” authoring tools that employ direct manipulation of the entities. Several of these limitations are listed as follows:

1) The process of creating the objects is not captured and saved in any form of a computer-based re-executable format. These tools perform a set of user-driven explicit editing operations (via direct create, delete, and modify of object entities), and they capture and store only the final representation of the object. As such, the author must manually repeat various steps of the creation and modification process in order to produce a different variation of the object. For example, using an explicit editing tool, if a user added entity A to an object, and then modified a portion of A, to produce A′, and then added B, then the system would save A′B. The editing process of going from A to A′ to A′B would never be captured. Only the result would be captured. As such, if the user wanted to produce a variation of the object in the form of AB, s/he would have to repeat the steps of adding an A and then going directly to the step of adding a B.

2) When an author makes a change to an object, there is a chance for making an error, since the author is performing the editing process manually, and directly upon the object. For example, if a user deletes and recreates an entity A that had been modified to A′ in the original object, there is a chance that the user will make a mistake and not perform the same explicit operation(s) that led to the creation of A.

3) In order to create an object that satisfies a set of conflicting requirements, an author must create multiple instances of the object, often with a large amount of duplication among the object instances. For example, a user would have to produce two objects, AB, and A′B in order to have two different representations of the object.

We should note that some explicit authoring tools provide functionality that captures the sequence of human interactions with a user interface, and allow these gestures to be replayed at other times in the explicit editing environment. Examples include Undo and Redo functions, as well as “history” and “trail” files that capture sequences of user interactions into separate, replay-able files. These “replay” functions help users work faster with their explicit editing tools, but they don't change the fact that the explicit editing tools still capture and store only the final representations of the objects.

Source Compiling Tools

In order to address some of the limitations posed by using explicit editing tools to create and modify source objects, the software community has focused on promoting a number of different technologies that help enable a single source object to become more versatile, and therefore, be useful for a variety of different needs. These technologies reduce the number of different source objects that need to be created and modified in the first place. The idea is to provide a means of post-processing a single source object into many different representations, rather than force the user to create multiple, different variations of the source object itself. This approach is based upon the premise that users still use an explicit editing tool to create each instance of a source object, but then employ a software system to post-process an object into different representations, eliminating the need to manually create variations of the source object using the explicit editing tool.

One technology that has been used to provide this kind of post processing of source objects is the compiler. The compiler is a form of software generator, whose purpose is to transform a source object from one representation into another, and ultimately, one that a computer can execute.

The first widely used transform engines were compilers that transformed human-created source objects from high-level, human readable languages, into lower level executable objects, in machine-readable languages, that could be processed by computers. The idea behind a compiler was that a transform operation would take as input, a pre-built, complete source object A, and transform it into a different representation of itself, called A′.

Over time, people added functionality to compilers that enabled them to perform more comprehensive tasks, with more built-in flexibility. The goal was to allow a programmer to write a source object for a program in a very high level form, with as few instructions as possible, and have the compiler reduce this program into the verbose and concrete instance required by the computer. Such approaches still require the programmer to write the source object representing the program in some language representation, and use this complete source object as an initial input to the transformation process. The goal of these approaches has been to make the overall programming process more efficient, and to automate the tasks of mapping a high-level concept, expressed in a few words as possible, into a concrete implementation that works on a computer.

In order to make a compiler become even more versatile, people enabled the compiler to accept configuration inputs that would alter the behavior of the compiler as it operated upon the input source object. These are known as parameterized compilers.

There are also numerous examples of approaches that pre-process a source object, prior to programmer interaction, as well as post-process a source object, after programmer interaction. 4GL's and code generators were approaches that pre-processed source objects, and generated stubs, or templates, that programmers would then manually add program code to, in order to finish the creation of implementation details in the source objects. A pre-processor is a form of macro or wizard that produces an explicit representation of one or more source objects that programmers can then edit manually in their explicit editing tools. Compilers, code checkers, and optimizers are examples of post processors that take manually created source objects, and transform them into different representations.

Some of the more recent examples of approaches that assist programmers in the manual creation of source objects include meta-programming, aspect oriented programming (AOP) and intentional programming (IP). However, none of these approaches eliminate the need for a user to create an explicit representation of a source object, no matter how high-level or small in granularity it may be. In stead, all of these approaches rely upon the programmer to create an explicit representation of a source object as a basis for performing post-processing operations. Detailed descriptions of these programming techniques can be found in Generative Programming, authored by Krzysztof Czarnecki and Ulrich Eisenecker (Addison-Wesley, 2000).

Meta-Programming

Meta-programming is an extension to existing compiler technologies. The user explicitly writes source code, and then adds “meta-code” to the source code. The compiler performs a transformation on the source code, using the meta-code as instructions. The meta-code serves as a means of parameterizing the behavior of the compiler. Meta-programming is a form of source object post-processing that involves embedding the configuration parameters for the post operations in the source object itself.

Aspect Oriented Programming (AOP)

With AOP, the user also explicitly writes a source object representing a program, and then explicitly creates another object that gets used by a post-processor to change the source object. The second program defines how the post processor is to apply “aspects” to the source program, by “weaving” code into it. Aspect oriented programming partly arose out of the need to assemble software components, and then weave code among them in order to implement features that could not be represented easily in the individual pre-assembled objects. For example, making a set of components “thread safe” was accomplished by first having the programmer explicitly create one or more source objects that would make calls to various methods in software libraries. Then, the programmer would run a post processor that would transform the source object(s) into a different, thread safe representation of the source object(s) by weaving snippets of code into the collective set. The approach still forces users to explicitly create source objects, and to then run post-processors on these source objects, in order to produce different, but still explicit variations of the source objects.

Intentional Programming (IP)

IP is a programming environment developed at Microsoft that enables programmers to use explicit editors to create source code in a format that reduces loss of information. IP allows programmers to load extension libraries into a special Integrated Development Environment (IDE). These library extensions add domain-specific language extensions, as needed for a given application. Programmers still explicitly create source objects in the form of a source tree, using an explicit editing tool. These source objects are then post-processed into lower-level formats using a multiple-stage transformational reduction engine that reduces the source objects into a limited set of reduced codes, or R-codes. This reduction process is keyed off of the source tree, which serves as a seed, or starting point for the reduction process.

IP also provides the IDE with extensions that affect not only the post-processing of a source tree object into reduced codes, but extensions that affect the visual representation of a source tree, and other extensions that affect tasks performed on a source tree, such as debugging.

Summary of Approaches

All of the approaches described in this section seek to improve user productivity in the creation of source objects by providing some form of pre-processing, or post-processing of source objects. The premise behind all of these approaches is that 1) users must still create some representation of a source object through an explicit editing means, and that 2) all processing of source objects takes place either before or after the explicit editing process performed by the user.

### SUMMARY OF THE INVENTION

The present invention provides a method and apparatus for dynamically creating software objects called DomainObjects. In one embodiment, these software objects represent any data that is in a computer usable form. In another embodiment, these software objects are source objects that can represent (but are not limited to representing) logic used in computing systems. Source objects contain, among other things, embodiments of logic, and these embodiments are referred to as System Logic Objects. The logic in System Logic Objects includes specification of the structure of a computer's memory, as well as the functionality and behavior of a computer's processors. Another embodiment of the present invention is a set of software object builders that dynamically generate System Logic Objects.

The present invention offers an approach for capturing process definitions for creating software objects, as supposed to prior art approaches that only allow for capturing a representation of an object explicitly. Prior art explicit editing approaches provide tools for users to create objects through explicit editing means. With such means, users can create and modify software objects by directly manipulating entities in the software objects, and by saving the resulting objects. The present invention provides a different approach, whereby a user creates an object called a Generative Model, which contains a process definition for creating an object by way of executing a set of software generators called Builders. Furthermore, the process definition allows the user to capture the process of object creation in a manner that can be re-executed to generate a wide variety of software objects.

With the present invention, as a user creates and modifies a Generative Model, a system of the present invention simultaneously processes said Generative Model to automatically and dynamically generate one or more instances of a software object. Rather than forcing a user to explicitly create, modify, and delete entities in software objects, and save only the result, the present invention provides a means of capturing one or more process definitions for creating software objects, as well as a means of changing and re-parameterizing these process definitions, and re-executing them, to produce new variations of said software objects. In the present invention, the user does not directly of explicitly edit the generated software object(s).

The method and apparatus of this invention perform a function known as the regeneration function. The regeneration function carries out the execution of the process definitions declared in one or more Generative Models, and produces families of related, but different instances of software objects. These objects can contain entities that represent logical operations performed by computing systems, which are referred to as System Logic Objects. The regeneration function is performed by a system of the present invention called the Regeneration Engine.

The regeneration function is comprised of ordered sequences of sub-construction tasks performed by software objects called Builders. A Generative Model prescribes a sequence of calls to Builders, and this sequence is referred to as a BuilderCallList. Each BuilderCall in a BuilderCallList defines the name of a Builder, and a set of parameter values to be fed to that Builder during processing in the regeneration function. Each Builder accepts a set of input parameters and a reference to a software object serving as a container, containing zero or more constructed objects, including DomainObjects, which are generic objects that can be used in computer systems to represent any kind of data and program function. In one embodiment, a type of DomainObject called System Logic Objects are generated to provide definitions of logic operations that are later executed by computing systems.

Under the guidance of the regeneration function, each Builder performs its own construction task upon the contents of the container. Construction tasks include adding, modifying, and deleting objects in the container. When a Builder has completed its construction task, it returns the container with updated contents. The overall behavior of the regeneration function is specified by the sequence and parameterization of Builders as defined by the BuilderCallList of a Generative Model. However, the regeneration function can substantially alter this behavior by disabling the execution of one or more of the Builders specified in the sequence, and by changing the input parameters feeding the Builders.

In the present invention, the prior art process of a user creating one or more software objects using an explicit editing tool is replaced by the process of a user creating one or more Generative Models, whereby each Generative Model is processed by the regeneration function to produce one or more generated instances of software objects. Because a Generative Model captures the complete process of generating software objects through the execution of a set of parameterized Builders, a user can easily call for the automatic re-execution of the creation process at any time using the same, or a different set of parameters, in order to generate different variations of the generated software objects. With explicit editing approaches, users must directly manipulate entities in the software objects.

Generative Models

Embodiments of the present invention include a text language for specifying Generative Models, a software application named Designer for creating said Generative Models and performing said regeneration functions utilizing said models, and an application named Customizer for creating sets of input parameters associated with said Generative Models.

In one embodiment of the present invention, the regeneration function operates by accepting as inputs, one or more Generative Models that define 1) a set of Builders, 2) their execution order, and 3) a set of default input parameters that serve as inputs to the Builders. In addition, the regeneration function accepts as input, a set of parametric inputs that override said default parameters, as well as instructions for disabling specified Builders. In one embodiment, a set of parameters used to override a set of Builder Inputs is called a Profile. Using these inputs, the regeneration function coordinates the execution of the Builders, called out by the instructions in the Generative Model. The regeneration function passes some of the input parameters that it receives, on into the individual Builders, and it coordinates the passing of the container from one Builder to the next.

In one embodiment of the present invention, the regeneration function performs the task of creating one or more System Logic Objects from scratch, using a definition of the construction process to be performed. The Generative Model defines this construction process, and the set of input parameters serve to configure the construction process. By changing the input parameters, and utilizing a single Generative Model, the regeneration function is able to instantiate different configurations of the construction process. Each potentially unique configuration of the construction process is able to produce a different generated set of output objects.

The language for specifying Generative Models includes a set of keywords, used in statements that represent calls to Builders. A Generative Model contains an ordered set of these statements, known as BuilderCalls. The BuilderCalls specify a set of Builders to be invoked, and the execution sequence of these Builders, and the default set of input parameters to be used by said Builders, in the absence of new parameters supplied to the regeneration function.

Designer

The authoring application for constructing Generative Models enables a user to view and edit a Generative Model, while simultaneously viewing the generated objects that have been produced by the regeneration function that processes the Generative Model in a particular configuration state. As a user changes the Generative Model, by adding, removing, modifying, enabling, and disabling BuilderCalls, the application simultaneously updates the generated objects by re-executing the regeneration function. In addition, when a user chooses to add or modify a Builder call in an open Generative Model, the application invokes one of a number of available user interface dialogs specific to that Builder, for the purpose of supplying new input parameters to the Builder. Input parameters may include references to entities within the generated objects that have been produced by the other Builders already specified by BuilderCalls in the Generative Model, preceding the Builder call being added or modified. Builder Calls can also include input parameters whose values include references to entities that are created by Builders specified later in the BuilderCall sequence.

When a user completes modification of the input parameters to a BuilderCall, or changes the disabled status of a BuilderCall, or reorders the sequence of BuilderCalls in the BuilderCallList, the regeneration function re-executes the sequence of BuilderCalls to produce an updated set of output objects.

Customizer

The present invention also provides an application for specifying sets of input parameters, used by the regeneration function to custom configure the construction process defined by one or more Generative Models. These sets of input parameters are known as Profiles. Profiles are saved independent of the Generative Models, and sets of Profiles can be combined as part of a process to generate a composite Profile that configures the regeneration function specified in a Generative Model.

Builders

Embodiments of present invention also include an extendible library of Builders that perform sub-construction tasks as part of the regeneration function. Builders are a set of software objects that perform unique functions upon the contents of a construction container, known as a Generative Container. Builders implement common interfaces that enable the regeneration function to coordinate the execution of a sequence of Builders. Each Builder takes as input, 1) a set of parameters, and 2) a reference to a Generative Container that holds zero or more software objects called DomainObjects that are being generated from scratch by the regeneration function. In one embodiment of the present invention, these DomainObjects contain entities that represent logic operations performed by computing systems, referred to as System Logic Objects. Each Builder performs a construction task upon the contents of the Generative Container, including creating new objects in the container, as well as deleting and modifying existing objects in the container, and returns control to the regeneration function that manages the overall process of coordinating the execution of all the Builders specified by the BuilderCalls in a Generative Model.

The Builders that are executed as part of the regeneration function are analogous to robots on a factory floor; and the generated DomainObjects are analogous to a product that is manufactured by a set of robots in an assembly line. As such, the present invention is a method and apparatus for constructing generic definitions of factories in the form of Generative Models. Furthermore, the regeneration function of the present invention is analogous to a system that reads factory definitions (i.e. Generative Models), and dynamically and automatically assembles and configures custom factory instances out of sets of robots, which take the form of Builders.

The present invention also builds upon the robotic factory analogy, by providing dynamic selection, assembly, and configuration of the software robots (i.e. Builders) that comprise a factory floor, at the time of demand, based upon the values of input parameters specified in Profiles. While a Generative Model represents a generic, default definition of a factory, comprised of Builders, as specified by the BuilderCalls in the Generative Model, the input parameters supplied to the regeneration function in the form of a composite Profile, cause the system to disable, enable, and configure specific Builders in the BuilderCall sequence, in order to customize the overall regeneration process.

### BRIEF DESCRIPTION OF THE DRAWINGS

Further objects of the present invention together with additional features contributing thereto and advantages accruing there from will be apparent from the following description of the preferred embodiments of the invention which are shown in the accompanying drawing figures with like reference numerals indicating like components throughout, wherein:

FIG. 1 is a block diagram showing the major components of regeneration system according to one embodiment of the present invention;

FIG. 2 is a flow chart depicting the process of regeneration;

FIG. 3A is a block diagram showing in detail how the major components of the regeneration interact with each other;

FIG. 3B is a flow chart depicting in detail the process of regeneration of the system shown in FIG. 3A;

FIG. 3C is a flow chart showing the process of Builder instantiation by the GenHandler component;

FIG. 4 is a block diagram showing the referential and containment relationships among the components of the regeneration system according to an embodiment of the present invention;

FIG. 5 is a block diagram showing the major components of the Designer application and their relationship with other components of the regeneration system according to one embodiment of the present invention;

FIG. 6 is a flow chart depicting in the process of using the Designer application;

FIG. 7A is a block diagram showing how the major components of the Designer application work to process BuilderCalls;

FIG. 7B is a flow diagram depicting the system depicted in FIG. 7A;

FIG. 8 shows the how GenElements and DomainObjects can be displayed in the Designer application;

FIG. 9 is a block diagram showing the major components of the Customizer application and their relationship with other components of the regeneration system according to one embodiment of the present invention;

FIG. 10 is a flow chart depicting in the process of using the Customizer application;

FIG. 11 shows the major components of a Rule Set (System Logic Object) according to one embodiment of the present invention;

FIG. 12 is a graphical View of an example Rule Set produced by the Rule Set Builder in one embodiment of the present invention;

FIG. 13 is a graphical View of another example Rule produced by the Rule Builder in one embodiment of the present invention;

FIG. 14 is a graphical View of an example Rule with Phase produced by the Rule Builder in one embodiment of the present invention;

FIG. 15 is a graphical View of an example Rule produced by the Chain Rule Builder using the Rule shown in FIG. 13;

FIG. 16 is a graphical View of an example Rule produced by the Chain Rule Builder using the Rule shown in FIG. 15;

FIG. 17 is a graphical View of an example Rule produced by the Chain Rule Builder to show the automatic reference adaptation capability of the Chain Rule Builder of the present invention;

FIG. 18 is a flow chart showing the process of automatic reference adaptation;

FIG. 19 is a diagram showing an example Action built by an Action Builder of the present invention;

FIG. 20 is a diagram showing an example Action with an “AND” Junction built by an Junction Builder of the present invention;

FIG. 21 is a diagram showing an example Action with an “OR” Junction built by an Junction Builder of the present invention;

FIG. 22 shows a BuilderCallList of Generative Model, showing two instances of a Chain Rule Builder call, named rule2, with one is set to disabled, the other to enabled;

FIG. 23 is a Rules View of generated System Logic Object showing first instance of rule2 Builder call enabled; and

FIG. 24 is a Rules View showing impact of toggling Chain Rule BuilderCalls.

### DESCRIPTION OF THE INVENTION

The present invention provides a method and apparatus for dynamically creating software objects, whereby said software objects can represent (but are not limited to representing) logic used in computing. An embodiment of the present invention is a system for reading and processing one or more Generative Models, and using the information to assemble, and configure a set of software components called Builders, into a generative processor that executes to construct one or more software objects. This system also uses parameter-based input data called Profiles, as well as other externally supplied data, to alter the way in which the system selects, assembles and configures the Builders, resulting in the creation of multiple unique generative processors, all from a single Generative Model.

Other embodiments of the invention include an application for creating said Generative Models, an application for creating Profiles, and a system for processing the generated software objects. In addition, embodiments of the present invention include applications and systems for managing all objects produced by the present invention, and for running the system as part of a larger computing system such as a J2EE application server.

It must be noted that co-pending U.S. patent application titled “Method and Apparatus For Creating Network Services,” filed Jun. 09, 1999, Ser. No. 09/329,677 provides background on the following method and apparatus and is hereby fully incorporated by reference.

In the present invention, there are two portions that cover 1) the systems used to create, edit, and execute Generative Models, and produce software objects called DomainObjects, and 2) a set of Builders that create executable System Logic Objects that can encode the logical behaviors of computing systems. In the first main part of the description, the regeneration process and the function of Generative Models are disclosed. This is followed by a description of the Designer application, an application for authoring Generative Models, and a description of the Customizer application, an application for authoring Profiles that contain parametric inputs for the regeneration process. In the second main part of the description, various types of Builders are disclosed to illustrate how System Logic Objects can be generated by the regeneration function, and represent major logical components that can be executed in a wide variety of computing environments.

I. Regeneration System for Automatically Assembling, Configuring and Executing Generative Processors (Regeneration)

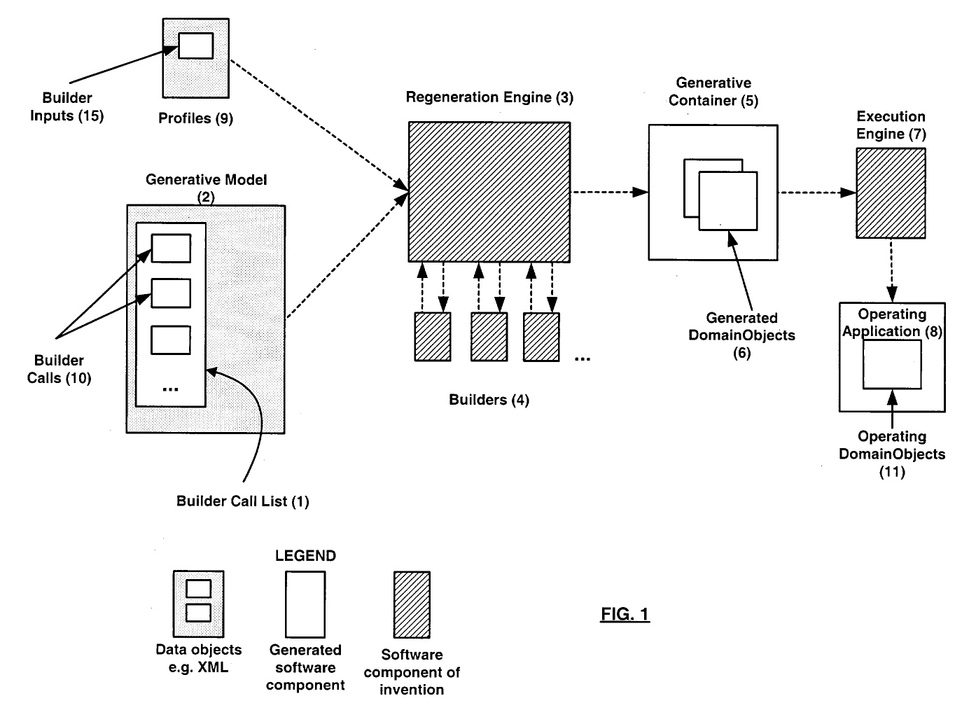

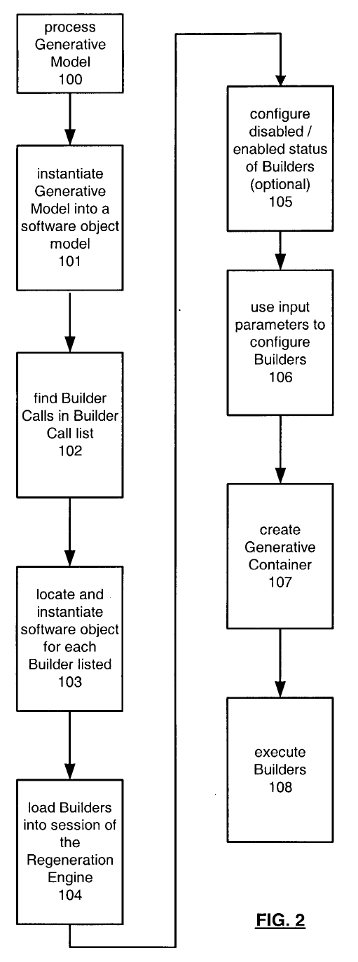

FIG. 1 shows an overview block diagram of a system embodiment of the present invention. The operation of the system depicted in FIG. 1 is shown in the flow chart of FIG. 2. The stripe-shaded boxes indicate the software components in this system embodiment of the present invention. The dotted boxes indicate the data objects in this system embodiment of the present invention. The white boxes indicate generated software components of the present invention.

FIG. 1 gives a general overview of the major components of the present invention: Generative Model (2), Profiles (9), Regeneration Engine (3), Builders (4), and Generative Container (5) (GenContainer). The “Gen-” nomenclature is a short-hand for the word “Generative.” Generative Model (2) further comprises a BuilderCallList (11), which is an ordered list of BuilderCalls (10). The BuilderCalls (10) are used by the Regeneration Engine (3) to select the various Builders (4) that will construct Domain Objects (6) in the Generative Container (5). The Generative Containers (5) is then fed to the Execution Engine (7). Subsequently, the generated Domain Objects (6) are optionally executed in the Operating Application (8).

Tracking along in FIG. 2, in step 100 the regeneration function in the Regeneration Engine (3) processes a Generative Model, or multiple Generative Models (2), along with a set of input parameters called BuilderInputs (15) in the form of one or more Profiles (9). Then, in step 101, the regeneration function instantiates the Generative Model (2) into a software object model. Then the regeneration function looks at the BuilderCallList (1) within this model to find a set of data objects called BuilderCalls (10) in step 102. The BuilderCallList prescribes a set of Builders (4), an order for their execution, a default disabled or enabled status for each Builder, and a set of default parametric input values for each Builder. Upon reading the BuilderCallList (1), in step 103 the regeneration function locates and instantiates the corresponding set of software objects for each of the Builders (4), and loads them into the session of the Regeneration Engine (3) in step 104.

Once the Builders have been loaded, the regeneration function, in optional step 105, configures the disabled or enabled status of the Builders. If a Builder has a disabled status, it is not executed. In step 106 the regeneration function uses the set of input parameters (BuilderInputs (15)) specified in the Profiles (9), along with the set of default parameters located in the BuilderCallList (1) of the Generative Model (2), to configure the Builders (4). Next, the regeneration function creates a Generative Container (5) (or GenContainer) in step 107. Generative Container (5) serves as a fixture for holding the software object entities that will be constructed and modified by the instantiated Builders (4). The regeneration function executes the Builders according the order in the BuilderCaIlList in step 108. In some instances, Builders can also delete objects in the Generative Container (5). So far the process, performed by the regeneration function, of instantiating a set of Builders (4) per the instructions specified in the Generative Model (2) is analogous to a set of highly automated machines assembling a physical factory out of robots (i.e. Builders). Following this analogy further, Regeneration Engine (3) is a piece of software that dynamically assembles these customized factories, whose purpose is to then generate software objects (including DomainObjects (6)) in the Generative Container (5).

Regeneration Process

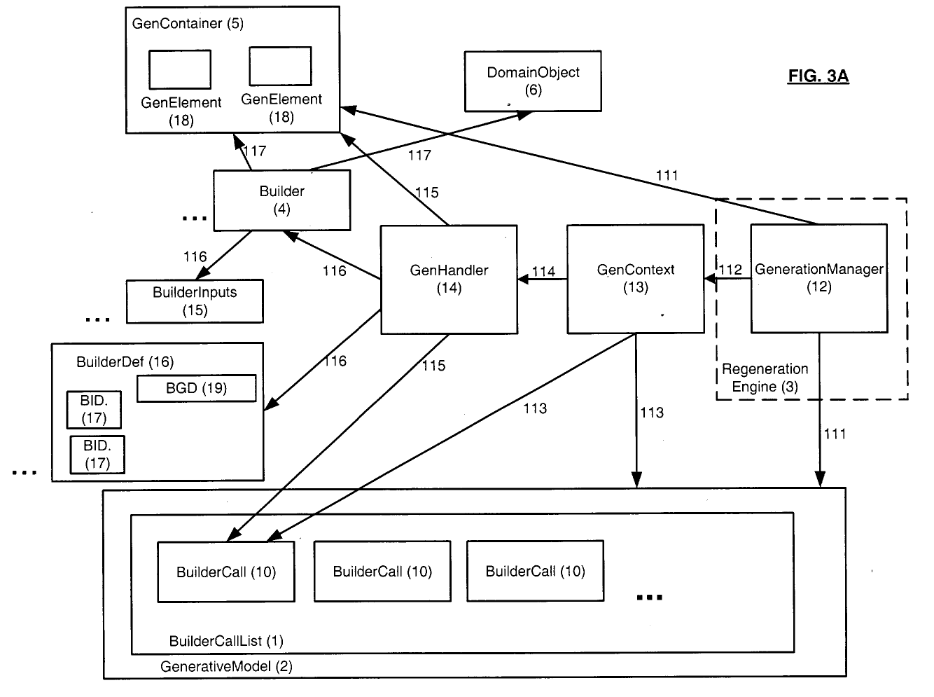

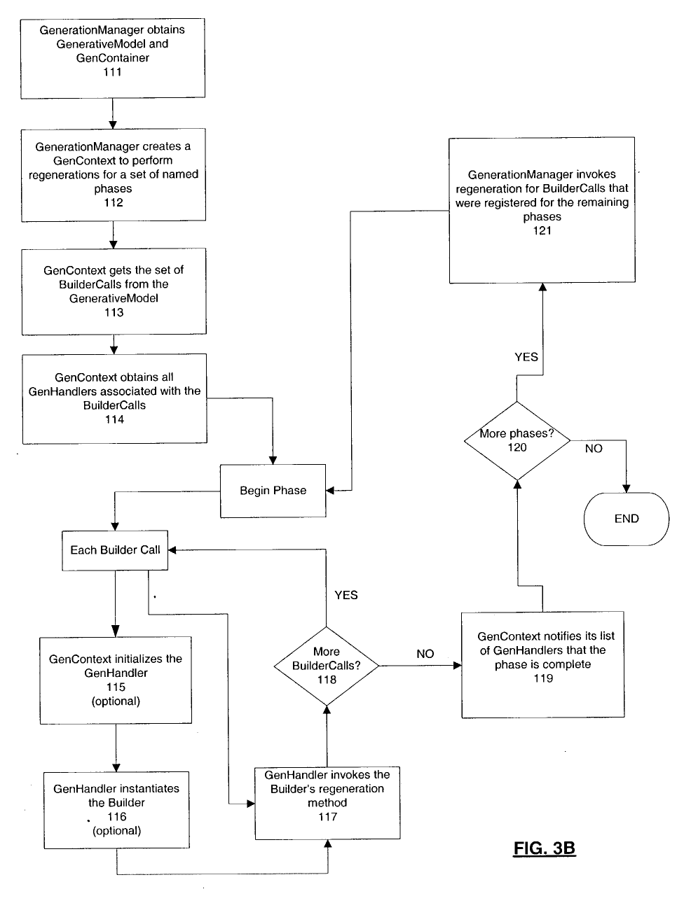

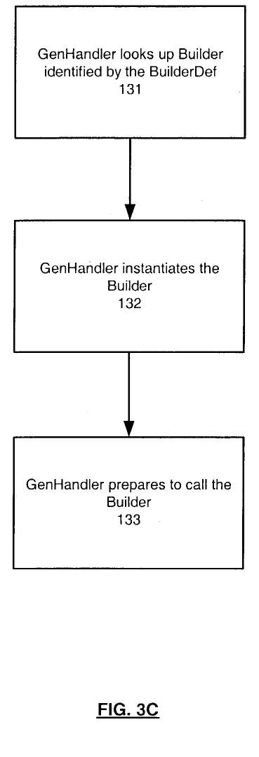

FIGS. 3A and 3B show, in detail, the regeneration operation portion of the embodiment of the invention depicted in FIG. 1. FIG. 3A is block diagram with arrows numbered with the step numbers found in the flow chart of FIG. 3B. They serve to show the components involved in each step of the process. Briefly, The Regeneration Operation involves creating a set of software objects (DomainObjects) from scratch, whereby a container for these DomainObjects named GenContainer is passed along a sequence of independent software generators (Builders), whereby each Builder references the GenContainer, and its contents, and adds, deletes, and modifies DomainObjects in the GenContainer. Furthermore, the Regeneration Operation involves passing parameter values into each Builder. The values serve to configure the generation behavior of that Builder. The reason that the process is called “re”-generation is because the generation of the sequence of Builders prescribed by the BuilderCallList, can be performed repeatedly with different sets of input parameters being fed into the Builders, and with different combinations of Builders being enabled and disabled.

The regeneration process begins in step 111 when the GenerationManager (12) obtains a Generative Model (2) and a GenContainer (5). A GenerationManager, as part of the Regeneration Engine shown in FIG. 1, is a software object that coordinates the execution of multiple Regeneration Operations defined by a Generative Model with respect to a GenContainer. Each Regeneration Operation is associated with a particular phase. These phases include, but are not limited to, “construction”, “post construction”, and “validation.” The GenerationManager obtains the GenContainer (5) holds the generated contents produced by the multiple Regeneration Operations.

In step 112, the GenerationManager creates and invokes the GenContext (13) object to perform the regeneration operation at each of the phases on the GenContainer and its contents. A GenContext (12) is a software object that performs the Regeneration Operation, for a specified phase, on the set of all the BuilderCalls (10) in a Generative Model (2).

In one embodiment of the present invention, the GenerationManager first triggers execution of the regeneration operation on the BuilderCallList (1) (of the Generative Model) for a “construction” phase. Once this first phase is complete, the GenerationManager triggers execution of another regeneration operation at a “post construction” phase. Any Builder used in the first phase that chose to register itself with the GenContext for this phase will have its regeneration function executed as part of regeneration of that phase. Finally, the GenerationManager will trigger execution of the Regeneration Operation for a “validation” phase. This multiple phase approach allows Builders to perform transformation, validation, and other operations on DomainObjects (6) after other Builders have had a chance to execute in prior phases. The number and names of phases for regeneration is variable and can be dynamically altered by the Generation Manager.

Before execution of the phases begins, in step 113 the GenContext retrieves a set of BuilderCalls (10) as defined in the BuilderCallList (1) of the Generative Model (2). The GenContext obtains the appropriate GenHandlers associated with the retrieved BuilderCalls in step 114. The GenContext maintains a list of the GenHandlers obtained. A GenHandler is a software object that coordinates and invokes the regeneration on an individual BuilderCall in a manner specialized for that Builder. Sets of Builders often have common and specialized interfaces and API's. Therefore, a GenHandler is able to provide a standard mechanism for calling these Builders in a specialized manner. A GenHandler is also able to perform a number of software operations that a whole set of Builders would normally have to perform respectively in their own regeneration functions. By enabling a single GenHandler to pre-process the inputs to the regeneration function of a Builder, a single GenHandler is able to isolate into one place computer program code that would normally have to be implemented over and over in Builders.

Next, the regeneration of the first phase begins. Step 115 is an optional step that begins the loop that the regeneration process performs for each BuilderCall listed in the BuilderCallList. In step 115, the GenContext instantiates and initializes the GenHandler if it has not been instantiated and initialized already, and gives it a reference to the BuilderCall and the GenContainer. If the GenHandler has been instantiated and initialized already, then the GenContext uses the existing GenHandler and passes it a reference to the BuilderCall and GenContainer.

In step 116, GenHandler instantiates and initializes the Builder if it has not been instantiated and initialized already, which is a three-step process shown in FIG. 3c. If the Builder has been instantiated and initialized already, then the existing Builder is used. In step 131, GenHandler looks up the Builder (4) identified by the BuilderDef (16). A BuilderDef is a software object that defines the different components of a Builder. A BuilderDef contains, but is not limited to containing:

(1) A set of input definition objects (BuilderlnputDefinition (17)), as well as the names of classes used to perform the Builder's Coordination and Regeneration functions. A BuilderlnputDefinition is a software object that defines information about a single input for a Builder. This includes the type of the input, constraints on the values that the input can have, default value(s), the name of an editor widget used to get and set values during the Builder's Coordination function (see step 117), and whether the input value is required, and visible by default. Many BuilderDef objects can reference a BuilderlnputDefinition. BuilderlnputDefinition objects can also inherit and override properties from other BuilderlnputDefinition objects.

(2) A set of BuilderGroupDefinitions (18) (only one shown in FIG. 3A). A BuilderGroupDefinition is a software object that defines information about a group of BuilderlnputDefinition objects. BuilderInputDefinitions can reference group definitions to allow the Builder to organize sets of BuilderInputs (15) to be associated with each other. For example, several BuilderInputDefinitions may be grouped under the same BuilderGroupDefinition so that they can all be made visible simultaneously.

(3) A reference to the name of a GenHandler object for the current Builder targeted. Coming back to FIG. 3C, in step 132, the GenHandler instantiates the Builder using the BuilderDef. Finally the GenHandler prepares to call the Builder in a manner that is specific to that Builder's interface in step 133.

In step 117, GenHandler invokes the regeneration method of the Builder. In this step, the Builder is passed the BuilderInputs (15), the GenContext (13), and the GenContainer (5) with its contents. The Builder uses the input from the BuilderInputs object in its regeneration method. BuilderInputs (15) is the software object that holds a set of BuilderInput objects that define the input values for a BuilderCall. A BuilderInput is a software object that holds a single input value and relevant metadata such as type for a Builder. A BuilderInput contains information about the kind of user interface widget to use for entering or modifying the value. For example, a BuilderInput may specify that a select list be provided to constrain values to an enumerated set, rather than provide the user with a freeform text area to enter values.

In this step also, the Builder performs the following types of operations: 1) add, modify, and delete contents of the GenContainer and its referenced objects, 2) invoke other Builders via the GenContext, 3) register Builders with the GenContext for regeneration at other phases, and 4) add or modify BuilderInputs in the BuilderCall. A Builder is a collection of software objects that perform Regeneration and Coordination functions. The Regeneration function is the process of applying one or more construction and transformation operations to the contents of a GenContainer, which is passed in and out of the Builder. The Coordination function is the invocation of a Builder Editor to gather input values for that Builder (see also section on Designer application). A Builder includes one or more software objects to perform these functions, and a BuilderDef that describes the components and relationships among these components. A Builder's regeneration function can access and utilize any external software libraries, and it can access external systems such as file systems and URL's, for the purpose of reading content and using it in its regeneration function.

A GenContainer (5) is a software object that contains a set of references to DomainObjects (6) that are being created, modified, and deleted by a set of Builders. Each DomainObject is “attached” to the GenContainer via a GenElement (19), which is a standard identifier for the DomainObject, and attachment mechanism for attaching the DomainObject to the GenContainer. The GenContainer maintains a set of GenElements. A GenElement contains a reference to one or more DomainObjects, as well as a set of references to parent, child, and peer GenElements. A GenElement provides a standard way for Builders and other software objects to understand the structure and relationships among the DomainObjects associated with a GenContainer, as well as a standard means of traversing the set of DomainObjects. A GenElement is analogous to a “bar-coded” identifier that gets attached to one or more parts on a fixture in a robotic fabrication line. Robots, which are analogous to Builders, are then able to identify parts in a standard way through use of the bar codes. GenElements serve to provide a layer of metadata that describes DomainObjects in a manner that allows the DomainObjects to have no knowledge of the Builders that construct them. On the other hand, a DomainObject is a software object that gets manufactured or transformed during the Regeneration Operation. A DomainObject can be any software object, from something simple like a String, to something complex like an XML Document Object Model. Moving on to step 118, it is determined whether there are more BuilderCalls to process. If there are, the system proceeds to work on the next BuilderCall and start again at step 114. If there are no more BuilderCalls, the phase is complete. When all the BuilderCalls have been processed, the GenContext notifies its list of GenHandlers that the phase is complete in step 119. In step 120, it is determined whether there are phases remaining. If there are none, the regeneration process ends. Otherwise, the GenerationManager invokes regeneration for BuilderCalls that were registered for the remaining phases in step 121.

Relationships Among Components

A more detailed depiction of the structural relationships among components of the present invention is given in FIG. 4. The boxes represent the software objects in an embodiment of the present invention. The dashed lines represent references. Nesting boxes represent containment relationships (i.e. an object is contained in another). GenerationManager (12) is part of Regeneration Engine (3). It contains references to GenContext (13), Generative Model (2), and GenContainer (5). GenContext (13) contains a reference to GenHandler (14). Each BuilderCall (10) within contains references to both BuilderInputs (15) and BuilderDef(16), which contains multiple BuilderlnputDefinition (17) objects. BuilderDef (16) references Builder (4). Note that only one set of BuilderInputs (15), BuilderDef (16), and Builder (4) is shown. There is one set for each BuilderCall (10) specified on the BuilderCallList (1). A plurality of sets is usually used for the construction of DomainObjects (6). Going further, GenContainer (5) contains multiple GenElements (18). Each GenElement references a DomainObject (6).

Object Generation

Once the regeneration function has initialized the Builders, it coordinates the execution of the prescribed Builders, by passing Generative Container from Builder to Builder, in the sequence prescribed by the BuilderCallList (1). Each of the Builders performs its regeneration function by executing a method that follows a common naming or signature convention, such as “OnRegen”. The purpose of this method is to create and add new objects to the container, as well as transform and delete objects already in the container. In this context, an object is any software component that is supported by the computing system hosting the operation of the Regeneration Engine. For example, a Builder could construct an instance of a String object and then add it to the Generative Container. A Builder could also create an instance of a more complex object such as an XML DOM (Extensible Markup Language Document Object Model), and then populate this object by adding XML elements and attributes. Other Builders could then add and transform elements of this instance of the XML DOM object. Objects such as String and DOM objects can support serialization into text formats, including XML, but this capability is optional in cases where the goal is to generate software object instances for immediate use after regeneration has completed.

As part of the regeneration process, the regeneration function of the Regeneration Engine can dynamically disable individual Builders, and change the input values to Builders, according to the Profile values, and any other interactions with external systems. A typical example of an external interaction would be for the regeneration function to call a database and receive the credit limit of a person, and use this information to determine whether to dynamically disable or enable a set of Builders, as specified by the BuilderCalls in a Generative Model. Upon completion of its regeneration task, the regeneration function returns a set of generated objects. In the present invention, these objects are referred to as DomainObjects.

The Regeneration Engine can also perform the regeneration function using an additional block of input data in the form of a request payload. For example, in the present invention, the Regeneration Engine can be set up to handle requests coming in to a J2EE compliant Application Server. These requests contain payload data, as well as data that maps to the specification of a Generative Model and Profiles. The regeneration function is able to use any of the inbound payload data in its processing of the Builders. In addition, individual Builders can access this payload data in their respective regeneration functions.

Parametric-Generative-Source Approach

The method embodied by the present invention is called the parametric-generative-source method. This method automatically creates source objects through dynamic configuration, assembly and execution of software factories. The parametric-generative-source method automates the assembly and instantiation of generative software components that are then responsible for creating one or more source objects from scratch. As such, this method is unlike prior art approaches such as compilers that employ static generators, whose behavior is predefined, and limited to processing already existing source objects. The parametric-generative-source method embodied by the present invention enables users to define process definitions for assembling and configuring complex, multi-stage, construction tasks, which are fully automated, and fully parameterized. Once the user has constructed a Generative Model, he or she is able to further define alternative parameters that correspond to changes to these construction tasks. As such, this method enables the user to define families of related construction processes in a Generative Model, and along with it, in a set of parametric Profiles. This is substantially different from the approach of users trying to build static code generators, such as compilers, that operate to transform source objects into variants of the same source objects. The focus of the present invention is on the automated generation of families of the software factories (i.e. where a software factory is deemed to mean a set of configured and executing Builders in the Regeneration Engine), which in turn, are responsible for generating families of source objects.

DomainObject Implementation

In one embodiment of the present invention, a DomainObject (6) of FIG. 1 is represented by a set of software objects. A number of Builders are able to create new instances of these objects, and other Builders are able to add, remove, and modify the state of these object instances via interaction with the object API's. For example, the Rule Set Builder (a type of Builder) constructs a new instance of a RuleSet object by accessing a Ruleset class, and adds the new object instance to the Generative Container. Next, the Rule Builder constructs instances of the Rule class, and adds these Rule object instances to the RuleSet object instance, by calling the RuleSet object's add( ) method. Other Builders are able to convert a RuleSet object into a generic XML element tree, by invoking a helper object, or by calling one of the methods on the RuleSet object. This enables the Builder to interact with this different representation of the same DomainObject using a different API. In this case, such a Builder could perform the conversion from one object representation to another by invoking a SAX (Simple APL for XML) event generator and handler system. This is just one of many interactions that Builders can have with DomainObjects.

The Builders of the present invention can generate and interact with any kind of object that can represent system logic, or any other form of information. For example, Builders can create and interact with objects provided by other sources. One example is Microsoft's Intentional Programming (IP) Tree system of software as described in U.S. Pat. No. 6,189,143, “Method and System for Reducing an Intentional Program Tree Represented by High-Level Computational Constructs.” The Builders of the present invention that generate system logic can accept input parameters that cause the Builder OnRegen functions to generate object instances that represent the elements of an IP tree that represent the same system logic that could be expressed by languages such as Java or C#. One should note that an IP tree is intended to be a higher-level representation of source data that can be transformed into different programming languages via a reduction transformation process.

System for Creating Generative Models (Designer)

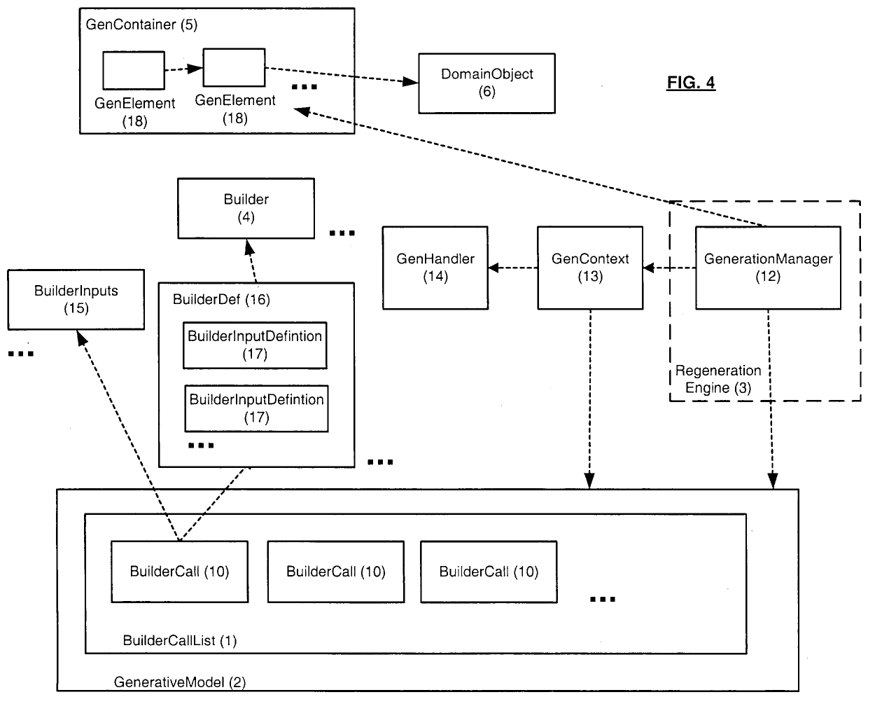

An embodiment of the present invention is a Designer application that is used by the user to create and edit Generative Models (2). The relationship of the Designer with the rest of the system is shown in FIG. 5. The Designer (20) enables a user to create new Generative Models, edit existing Generative Models, and delete these models. The Designer is an “explicit” authoring tool that provides the user with direct manipulation control over the contents of a Generative Model. In another embodiment of the present invention, one could provide a set of Builders that would enable the regeneration process to produce a Generative Model. This would allow users to create a Generative Model that would contain the instructions for the system to create another Generative Models, and so forth. The fact that the Designer is an explicit authoring tool for creating Generative Models should not be confused with other “explicit” authoring tools used to create software objects through direct manipulation of the software object entities. In the present invention, while a user creates a Generative Model using an explicit approach, it is the combination of a Generative Model with the regeneration function of the Regeneration Engine which leads to the automatic production of instances of generated software objects.

When a user opens a Generative Model (2) in the Designer, the Designer provides the user with a view of the BuilderCallList (1). This view is called the BuilderCallList0 View (21). The BuilderCallList View provides numerous ways of viewing the BuilderCalls in a Generative Model, including a tabular view, sequential list view, and a hierarchical tree view based on attributes of BuilderCalls. In addition, the Designer application provides filters and sorting utilities that can be applied to the view to affect its contents.

The Designer also provides an extensible set of views for viewing and interacting with the generated objects, including the DomainObjects (6) produced by regeneration. The Designer is connected to the Regeneration Engine (3) and the Execution Engine (7), and other parts of the system of the present invention as shown by the dotted lines with arrows. These connections mean that when a user changes a Generative Model, a Profile, or other externally supplied data, the Designer is able to update the views of the Generative Model entities, as well as the views of the generated output objects. In the Application View (23) the user is also able to view and interact with the Operating Application (8), and Operating DomainObjects (11), in cases where DomainObjects can perform executable operations—such as operation of a web application. Thus the effects of the user-made changes in the Generative Models can be displayed immediately.

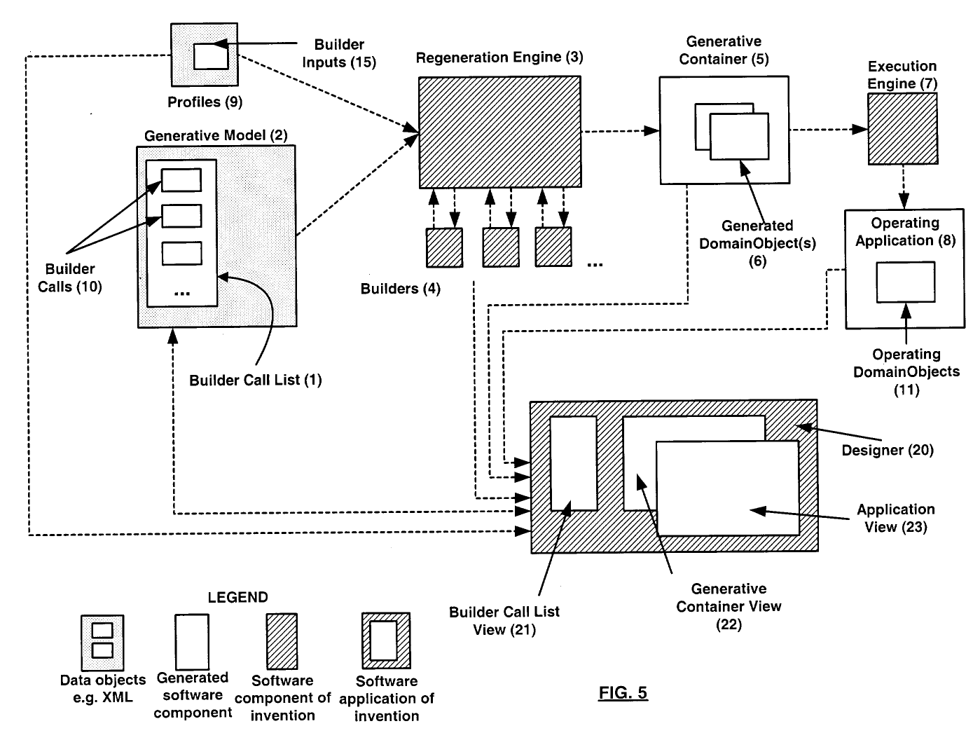

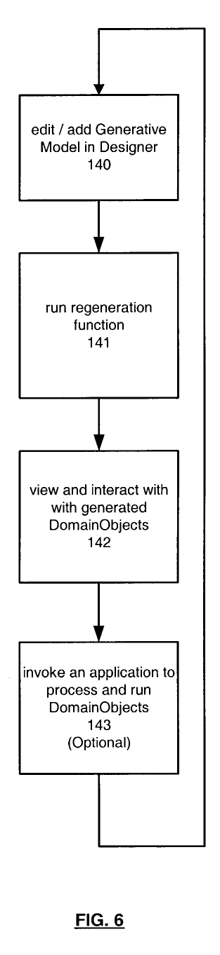

FIG. 6 shows the process in action. In step 140, the user either creates a new Generative Model in the Designer or edits an existing one. Then in step 141, the user runs the regeneration function with the new or edited Generative Model. Then in step 142, the user views and interacts with generated DomainObjects. Next, in an optional step 143, the user can invoke an application to process and run Domain Objects. In the present invention, this includes execution of DomainObjects in a rules engine execution environment used to test the operation of these DomainObjects. If more changes are needed, the user can go back and edit the Generative Model in step 140.

It is important to note that many times, the generated DomainObjects form a subset of objects that collectively represent an application (e.g. a web application). Such web applications contain many document-based and compiled software entities representing structure, such as Java Server Pages (JSP's), Java classes, and other objects. In one embodiment of the present invention, the execution of DomainObjects takes place in the context of the larger execution of a web application. In one embodiment of the present invention, the system logic within the DomainObjects controls functions and behaviors such as page navigation, user interface configuration, workflow tasks, and data transformation tasks.

Editing BuilderCalls

The main task in editing Generative Models involves adding, deleting and modifying BuilderCalls, as well as reordering BuilderCalls, and setting their enabled and disabled states. When a BuilderCall is marked as disabled, the regeneration function skips over it, causing the Builder to not participate in the overall generation process. The user can also interact with the Builder user interfaces named DynamicBuilderInputs to specify which Builder inputs on specific BuilderCalls should be exposed as public outside the Generative Model. Public Builder Call inputs support having their values replaced by externally supplied values via Profiles (see the section titled “Customer”).

FIGS. 7A and 7B illustrate in detail the operation of the Designer application embodiment depicted in FIG. 5. FIG. 7A is block diagram with arrows numbered with the step numbers found in the flow chart of FIG. 7B. They serve to show the components involved in each step of the process. The process can be described briefly as follows. When a user instructs the Designer to add a new BuilderCall to a Generative Model, or to edit an existing BuilderCall, the Designer utilizes a dynamic instantiation process for creating the Builder's user interface, which comprises DynamicBuilderInputs (27 and 28). This process includes the following main steps:

1. find information about the Builder (4) in the BuilderDef (16) object,

2. use BuilderlnputDefinition (17) and BuilderGroupDefinition (19) objects specified in the BuilderDef to instantiate software UI widgets (25) into a Builder Editor (26), and

3. instantiate a Coordinator software object (23) to perform event handling for the Builder Editor (26) during user interaction. In addition, the Designer (20) constructs an additional user interface (28) for each BuilderlnputDefinition for specifying an alternative source for the input value, which is called a Profile value.

The flowchart of FIG. 7B shows the process in detail. In step 151 of FIG. 7B, when the user wants to add a new BuilderCall, or modify an existing BuilderCall (10) in a Generative Model (2) (not shown), the Designer application (20) dynamically instantiates a Builder Editor (26) to handle the gathering of BuilderInput values and Profile values via interfaces (27 and 28) for the BuilderCall (10). A list of N DynamicBuilderInputs interfaces are shown in this example Designer application.

Then in step 152, the Designer (20) obtains a BuilderDef object (16) for the targeted Builder (4), and looks up the set of BuilderInputDefinitions (17) and BuilderGroupDefinitions (19) in order to construct the Builder Editor (26). If this is a new BuilderCall, the BuilderDef object creates a BuilderCall (10) and initializes its values, as specified in the BuilderDef (16) file. In one embodiment, the step of obtaining builder definition further comprises the steps of 1) obtaining the name of a type of builder to use in constructing a new builder call in the builder call list; and 2) using the obtained name to obtain the builder definition object.

In step 153, for each BuilderlnputDefinition, the Designer constructs a DynamicBuilderInput, which can be considered as filling the BuilderlnputDefinition with the specific value of the corresponding BuilderInput in the BuilderCall. The DynamicBuilderInput also contains the widget with which the input will be edited inside the Editor. The Designer constructs a dialog box for the Builder for the purpose of 1) gathering values for each BuilderInput from the user, 2) enforcing constraints among BuilderInputs, and 3) enabling the user to specify the source of a BuilderInput Profile value to come from an external source.

In step 154, the Designer instantiates the Builder's Coordinator Function (23) as specified in the BuilderDef (16). The Coordinator is given an opportunity to modify the list of DynamicBuilderInputs, including adding or removing them and changing their visibility, values, group assignments, the list of choices within the widgets, etc.

In step 155, the Designer instantiates the set of Builder UI Widgets (25) declared in the DynamicBuilderInput objects, and decides whether to place the UI controls in the Builder Editor. In addition, the Designer constructs the auxiliary user interface for each DynamicBuilderInput to gather Profile values (28). The BuilderGroupDefinitions (19) are used to create UI logic to control the showing and hiding of grouped sets of BuilderInput UI controls.

The Designer sets up the Coordinator as a handler of change events generated by the user in the Builder Editor in step 156. The Designer fires change events in response to user interaction with the Editor, causing the Coordinator to process and update the DynamicBuilderInputs. A function in the Coordinator is called when a BuilderInput changes, and the Coordinator is able to change values in BuilderInputs, generate errors and warnings that are made visible in the Builder Editor.

The Designer makes the GenContainer available to the Coordinator in step 157. This enables the Coordinator to get and reference DomainObjects referenced by the GenContainer. The Coordinator can modify DynamicBuilderInputs, including adding and removing them, and changing their values and properties such as visibility.

Finally in step 158, when the user has completed the editing task, the Designer saves the updated DynamicBuilderInput values in the BuilderCall. If the BuilderCall is new, the Designer inserts it into the BuilderCallList (not shown).

Views

In one embodiment, the designer application also provides two views for interacting with a type of DomainObjects called System Logic Objects. The first view is called the Rules View (see table 1 for a description on Rules). This view provides a graphical depiction of data structures as boxes. The view represents actions as boxes containing nested boxes representing calls from that action to other actions. The view represents rules as diamonds with connective links showing references to structures in the rule's conditions, and connective links showing references to called actions. The view also provides popup display of a rule's conditions and actions. The view represents junctions using the standard schematic representations for logical symbols (i.e. AND and OR junctions). The view also represents externally exposed states, known as Phases, as boxes. A more detailed description of the entities represented in the Rules View follows. The second view for interacting with System Logic Objects is a text based view of an XML tree representation of the generated System Logic Objects.

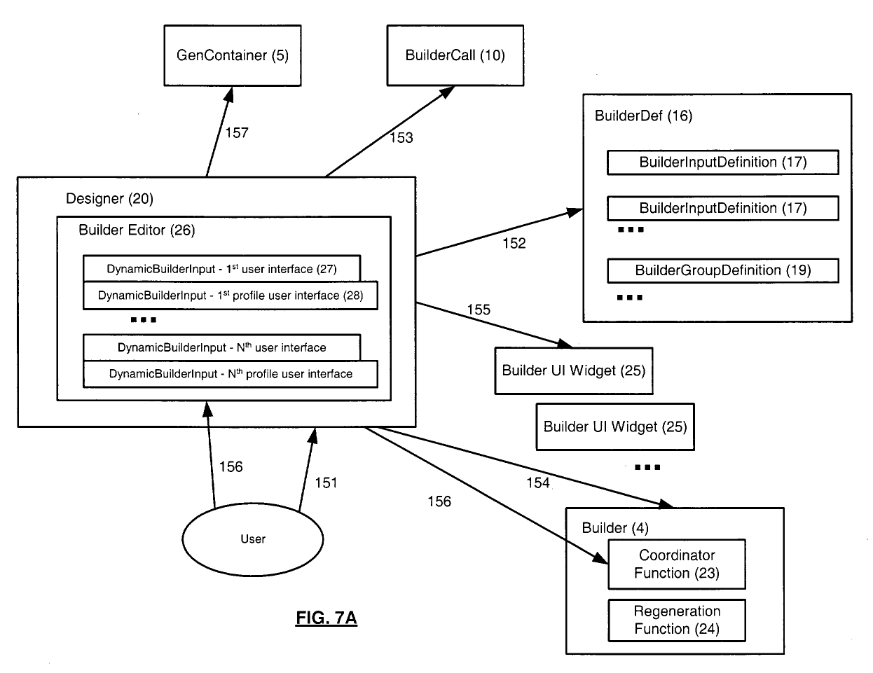

The Designer also provides a mechanism for invoking software objects called Views. FIG. 8 shows an example View (31). The Designer invokes a View by passing it a reference to an active GenContainer (5). A View is a graphical or text-based rendition of the contents of a GenContainer (5). As shown by the arrows in FIG. 8, a View can display the GenElements (18) and the relationships among GenElements, or it can display the DomainObjects (6), and the relationships among DomainObjects, or it can display a combination of both. In particular, a View can show any parent-child and peer-to-peer relationships among GenElements and/or DomainObjects. The display is shown through GenElement Visual Elements (31) and DomainObject Visual Elements (32). An active GenContainer is one that is associated with a Generative Model that is opened by the Designer. When the GenContainer changes, the view is notified so that it can update itself.

Views provide a means of notifying the Designer about the current state of a GenElement. For example, a View can notify the Designer that a GenElement has been selected, or highlighted. Views also provide a means of requesting the Designer to modify the Generative Model. For example, a View can request the Designer to delete or disable BuilderCalls in the BuilderCallList.

System for Creating Profiles (Customizer)

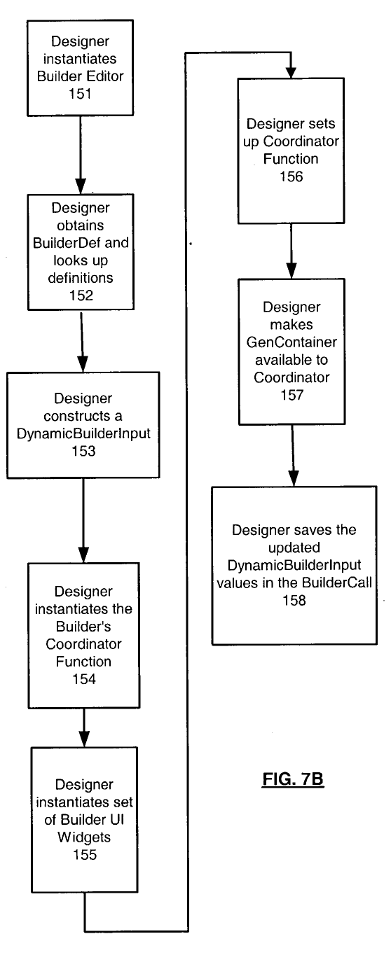

FIG. 9 is a block diagram showing an embodiment of the present invention called the Customizer (34) and how it relates with the other system components. The Customizer is an application for creating Profiles (9) and testing the impact they have upon the regeneration process relative to one or more Generative Models (2). The Customizer allows a user to open a Generative Model and then define one or more Profiles comprised of parameters in the form of name and value pairs.

The Customizer also provides functionality for creating Profile Sets. A Profile Set is a body of data that defines a set of named parameters and their types. When a user is working in the Designer, he or she can mark BuilderCall inputs as public, and also associate that input with a parameter defined in a Profile Set.

Within the Customizer application, when the user specifies the parameter values for a Profile associated with a Generative Model, the Profile Set type definitions help the application generate the appropriate user interface control for obtaining an input value. For example, a Profile Set parameter may specify that the input is a Boolean true/false type (as supposed to a String type). Knowing the type as Boolean enables the Customizer application to automatically generate the appropriate user interface control, which in this case is a drop down selection list of N enumerated values.

The Customizer provides users with functionality for adding, deleting and modifying Profiles. When a user creates a Profile, the application provides a view called the Profiles View (35), which shows the Profile's parameters and enables a user to enter values. This view also provides view and management functions for working with all of Profiles that may be associated with a Generative Model.

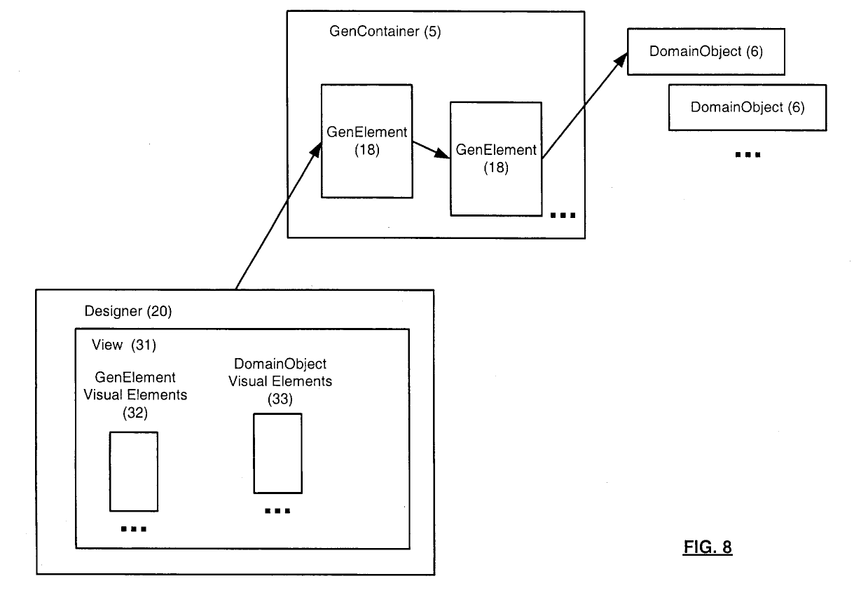

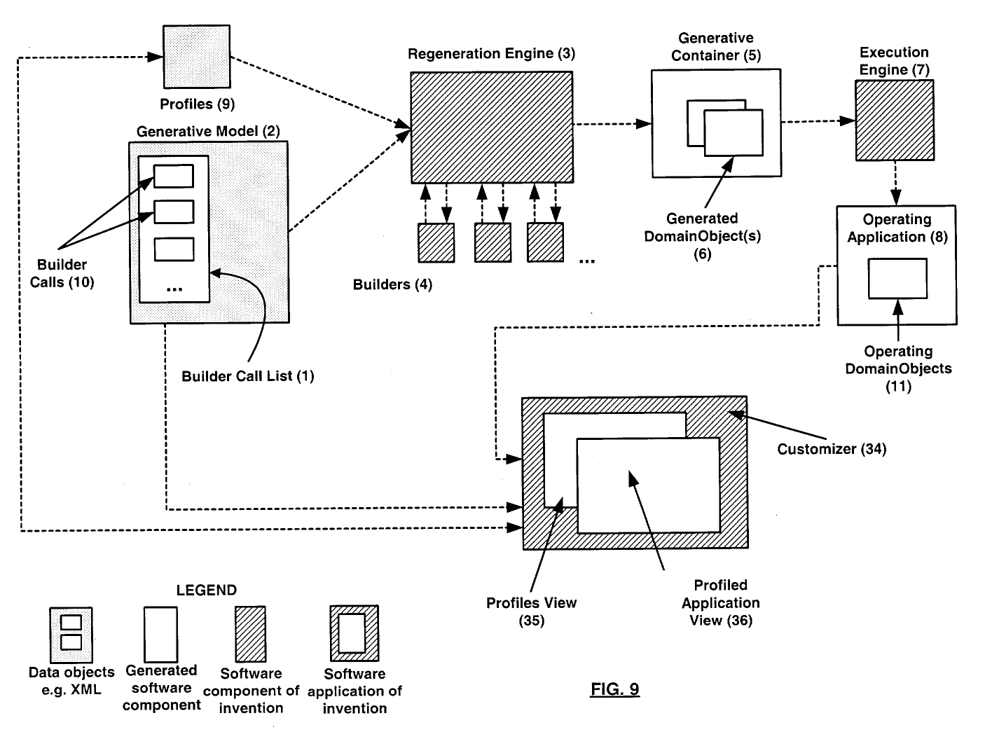

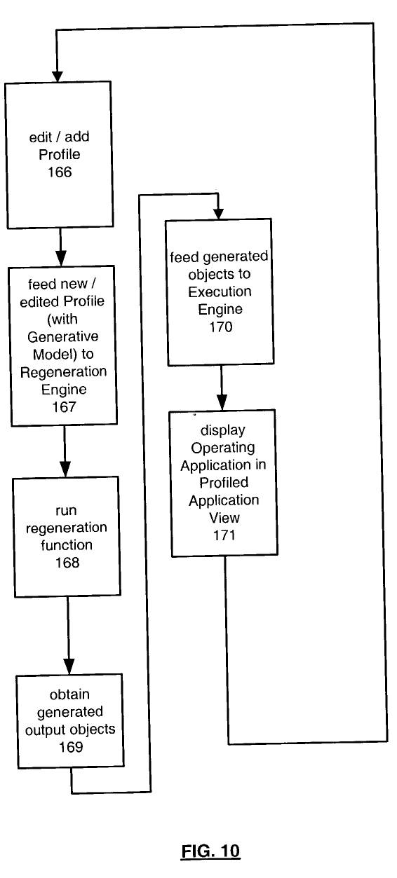

The Customizer application also provides functionality for testing a Profile by feeding its values, along with a Generative Model, to the Regeneration Engine. The process of concurrent editing and testing within the Customizer offers convenience to the user. FIG. 10 shows the process. In step 166, the user begins by either adding a new Profile or modifying an existing one. Then, the Customizer application tests the Profile by feeding its values, along with a Generative Model, to the Regeneration Engine in step 167. Then the Regeneration Engine performs the regeneration function in step 168, obtains the generated output objects in step 169, and feeds them to the Execution Engine, which creates the Operating Application (8) in step 170. Finally, the Customizer provides a view called the Profiled Application View (36) of the running Profile-specific application in step 171. The application is Profile-specific in the sense that it is unique to the Profile that is used by the Regeneration Engine. If a different Profile is used, a different application will be produced, even if the Generative Model is the same.

II. Builders and System Logic Objects

The second part of the description discloses embodiments of the present invention including Builders and System Logic Objects. Builders are essential construction mechanisms by which System Logic Objects are created. Before the operation of the Builders and the mechanism of System Logic Objects are discussed, important terms and their definitions are given in Table 1 below.

TABLE 1

| Term | Definition |
|---|---|
| Computing System | A Computing System is a computer that has one or more |
| | processors and memory devices that manage and change the state |
| | of data over time. |
| System Logic Object | A System Logic Object is a software object that represents a |
| | body of System Logic. System logic is a description of structure, |
| | functionality, behavior, and states of a computing system. |
| | System logic can be described in any number of languages. An |
| | example of system logic is the “if condition is true, then perform |
| | action” statement. A system logic object can represent system |
| | logic in number of different ways. Examples include a String of |
| | text, or an abstract source tree representation, as is used in |
| | Microsoft's Intentional Programming system. |
| Structure | A Structure is an allocated portion of memory in a computing |
| | system that holds stateful data. A structure has a name and a |
| | type. |
| State | A State is an instance of a computing system characterized by the |
| | data in its Variables, or the set of values in a set of the structures |
| | of a computing system at some point in time. |
| Variable | A Variable is a structure in a computing system, whose value is |
| | assumed to change over time. . A Variable optionally has a data |
| | type definition represented by an XML schema (according to the |
| | W3C schema definition, or by another means of representing a |
| | schema (i.e. database table schema) |
| Unit of Functionality | A Unit of Functionality is a set of computing tasks that change |
| | the state of a computing system. A unit of functionality can |
| | contain calls to other units of functionality. . A unit of |
| | functionality is commonly known as a method in Object Oriented |
| | programming languages such as Java. A single unit of |
| | functionality can be expressed in many different languages, |
| | including an XML language containing metadata, or a traditional |
| | source language such as Java. An example of a basic unit of |
| | functionality is the following: |
| | while (i<10) { |
| | system.out.println(“hi there”); i+=1;} |
| | In this example, the sub-units of functionality are the while loop, |
| | the println function, and the addition operator. A unit of |
| | functionality can optionally have a name. |
| Pattern | A Pattern is an archetype serving to describe structure and |
| | relationships in data. Examples of patterns are 111010001000 |
| | and “sequence of 5 even numbers”. |
| Condition | A Condition is an element of a System Logic Object that defines |
| | an evaluation statement that determines if the data in one or more |
| | Variables contains a set of specified Patterns. An example of a |
| | Condition is (a == 5), and (a > b/5.0). A Condition can be |
| | evaluated to “true” or “false”. The degenerate form of a |
| | Condition is “true”, whereby the Condition always evaluates to |
| | true. |
| | Optionally, a Condition can have a Name that enables it to be |
| | referenced by other entities in a System Logic Object. |
| Action | An Action is an element of a System Logic Object that defines a |
| | unit of functionality performed by a computing system. When an |
| | Action is executed in a computing system, it can change the State |
| | of a computing system. The degenerate form of an Action is null, |
| | or no action. An Action can contain Action Calls. Following is |
| | an example of the definition of an Action: |
| | action22( ) { |
| | System.out.println(“Hi There”); |
| | } |
| | Optionally, an Action can contain a definition of a Variable to |
| | track the State of the Action as it may change over time during |
| | operation if a computing system. In addition, an Action can |
| | contain an Action Call to another Action that serves to change the |
| | State of said Variable to reflect that the Action has executed, |
| | and/or that a set of the Action's Action Calls have executed, or |
| | failed to execute properly. Such a Variable enables the |
| | computing system to track an Action's execution Behavior over |
| | time. |
| | An Action has a Name that enables it to be referenced by other |
| | entities in a System Logic Object. |
| | Optionally, an Action can accept a set of ordered arguments. |
| Action Call | An Action Call is an element of a System Logic Object that |
| | defines a call to a named Action along with a set of ordered input |
| | arguments to be passed to that Action. There can also be no |
| | arguments. An example of an Action Call follows: |
| | action2( “foo”, “bar”, 5); |
| | Here, the Action Call calls Action action2, and passes it |
| | the ordered set of arguments “foo”, “bar”, and 5. |
| | A Method Call is a type of Action that contains one or more |
| | Action Calls. Following is an example of a Method Call: |
| | action1( ) { |
| | action2( “foo”, “bar”, 5); |
| | } |
| Behavior | A Behavior is an element of a System Logic Object that defines a |
| | “cause and effect” relationship between a specified Action that is |
| | to be executed when a specified Condition evaluates to true. |
| | When a Behavior is applied to a computing system, the Condition |
| | is evaluated relative to the State at the time of execution, and |
| | based upon the outcome, the Action is either Executed or not. |
| | The “Application” of a Behavior is considered to be a type of |
| | Action. A Behavior is comprised of a Condition Test, and an |
| | associated sequence of one or more Action Calls that form the |
| | Action. A Condition Test is a computing operation that defines |
| | the evaluation of a Condition with the possible execution of the |
| | Action, but only in the case when the Condition evaluates to true. |
| | An example of a Behavior is as follows: |
| | If (a>10) { |
| | action3( ); |
| | } |
| | Here, the condition is (a>10), the Condition Test is if (a>10) { }, |
| | and the single Action Call is action3( );. |
| | Optionally, a Behavior can have a Name that enables it to be |
| | referenced by other entities in a System Logic Object. |
| Phase | A Phase is comprised of a Variable, and a set of allowed |
| | enumerated values that the Variable can maintain. A Phase |
| | serves to define a global State for a Rule Set. |
| Rule | A Rule is an element of a System Logic Object that defines a |
| | collection of one or more Behaviors. The degenerate form of a |
| | Rule is a single Behavior. The degenerate form of a Rule can also |
| | be called a Simple Rule. A Simple Rule represents an “IF-Then” |
| | Behavior. When a Rule is applied to a computing system, its |
| | Behaviors are applied in a sequence. The “Application” of a Rule |
| | is considered to be a type of Action. |
| | Optionally, a Rule can have a Name that enables it to be |
| | referenced by other entities in a System Logic Object. |
| | Optionally, a Rule can define a Variable to track the State of the |
| | Rule as it may change over time during operation if a computing |
| | system. In addition, a Rule can contain an Action Call to an |
| | Action within the Actions of its Behaviors, whereby the Action is |
| | a computing operation that changes the State of said Variable to |
| | reflect that the Rule has executed and called one of its Actions in |
| | a certain manner. Such a Variable enables the computing system |
| | to track a Rule's execution Behavior over time. For example, |
| | such a Variable could indicate that RuleX had been applied - |
| | known as “firing”, and that it is Else Action had been executed. |
| If-Then-Else Rule | An If-Then-Else Rule is a type of Rule comprised of two |
| | Behaviors, where the Condition of the second Behavior is the |
| | logical “NOT” of the Condition of the first Behavior, and where |
| | the Action of the second Behavior is optionally different from the |
| | Action of the first Behavior. The two Behaviors are referred to as |
| | the Then behavior, and the Else Behavior respectively. The |
| | Condition of the Then Behavior is known as the Test Condition. |
| | An example of an If-Then-Else Rule is: if (a>5) { action1( ); } else |
| | { action2( ); };. Here, the Test Condition is (a>5). The Then |
| | Behavior has a Condition which is the Test Condition, and the |
| | Action action1( );. The Else Behavior has a Condition which is |
| | the logical “NOT” of the Test Condition (!(a>5)), and the Action |
| | action2( );. |
| Base Rule | A Base Rule is a an element of a System Logic Object comprised |
| | of a Simple Rule, and an If-Then-Else Rule, whereby the Action |
| | of the Simple Rule is the application of the If-Then-Else Rule - |
| | see definition of a Rule, where the application of a Rule can be |
| | considered to be an Action. The Condition of the Simple Rule is |
| | known as a Pre-Condition, because it determines whether or not |
| | the If-Then-Else Rule is to be applied or not. An example of a |
| | Base Rule is: |
| | If (a>5) { |
| | If (b>10) { |
| | action1( ); |
| | } else { |
| | action2( ); |
| | } |
| | } |
| | Optionally, a Base Rule can have a Name that enables it to be |
| | referenced by other entities in a System Logic Object. |
| Rule Set | A Rule Set is a named element of a System Logic Object that |
| | contains a set of Rules, Actions, Variables, and optionally, a |
| | Phase. A Rule Set has a name, and serves as a container for name |
| | scoping purposes. For example, there could be two Rules in a |
| | System Logic Object both named Rule1. If each Rule were to be |
| | placed in a different Rule Set, then it would be possible to |
| | uniquely identify each Rule through a fully qualified name |
| | RuleSet1/Rule1 versus RuleSet2/Rule1. A rule set can have |
| | structures that reference other rule sets, for the purpose of |
| | supporting assemblies of rule sets comprised of assembled |
| | component rule sets. |
| Operating | An Operating System Logic Object is a set of software objects |
| System Logic | operating on a computing system, which exhibit the behaviors |
| Object | defined in a system logic object over a period of time. The |
| | computing system begins operation by having its data structures |
| | set to an initial state. The computing system performs an initial |
| | action, which triggers the execution of other actions. These |
| | actions execute behaviors by testing for the existence of patterns |
| | specified by the behaviors, and executing their actions when the |
| | tests are met. Over a period of time, a computing system will |
| | execute a number of its behaviors, and will have performed a |
| | number of its actions. |
| Method Call | A Method Call is an Action Call in a system logic object that |
| | includes a set of pre-configured input values, or arguments, that |
| | are passed into the Action as part of execution. |
| Junction | A Junction is comprised of a type of Rule called a Junction Rule, |
| | whose Condition Test is comprised of a set of Conditions, |
| | separated by logical AND or OR statements. A Junction is also |
| | comprised of a Variable that maintains the state of the Junction |
| | Rule's Condition Test. A Junction Rule's Action changes the |
| | state of this Variable when the Condition Test evaluates to true. |
| | Following is an example of a Junction: |
| | If ((a>10) && isActive(“action2”)) { |
| | junction1.setActive( ); |
| | } |
| | In this example, the Junction performs an “AND” operation on |
| | two Conditions, and if the Condition Test evaluates to true, then |
| | the Junction calls an Action that changes the value of the |
| | junction's Variable to reflect that the evaluation resolved to true. |
| | Optionally, a Junction can have a Name that enables it to be |
| | referenced by other entities in a System Logic Object. |

Description of Builders for Constructing System Logic Objects

The following sections describe the various types of Builders that are used in the present invention. Described are System Logic Builder, Rule Set Builder, Phase Builder, Base Rule Builder, Chain Rule Builder, Rule Action Builder, Rule Condition Builder, Action Builder, Junction Builder and Linked Rule Builder.

System Logic Builder

A System Logic Builder is a Builder that operates upon a set of DomainObjects where the DomainObjects are System Logic Objects. A System Logic Builder can create, modify, and delete a System Logic Object within a GenContainer. A System Logic Builder has a BuilderInput for specifying a name, which can be used by the Builder's regeneration function to uniquely name generated DomainObjects and GenElements in the GenContainer.

A System Logic Builder can optionally have a BuilderInput that obtains the name or names of Rule Sets that define the scope in which the Builder should operate. For example, a Builder could use such an input to obtain the name of a Rule Set, and then limit the scope of subsequent BuilderInput values to include references only to System Logic Objects within that Rule Set. In addition, such a BuilderInput could enable the Builder to limit the scope of its regeneration operation to the contents of said Rule Set.

A Generative Model can contain a set of BuilderCalls to a set of System Logic Builders. When such a Generative Model is regenerated, it can produce one or more System Logic Objects, as generated DomainObjects.

Rule Set Builder

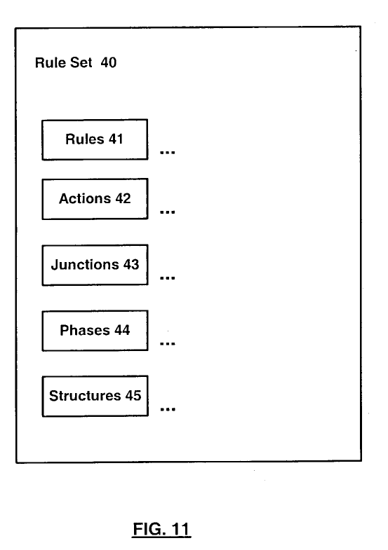

The Rule Set Builder constructs a named System Logic Object (also known as a Rule Set), which serves as a container, or repository for a set of Rules, Actions, Junctions, Phases and Structures, including references to entities external to the System Logic Object. As shown in FIG. 11, Rule Set (40) comprises zero or more Rules (41), zero or more Actions (42), zero or more Junctions (43), zero or more Phases (44), zero or more Structures (45), and zero or more other objects. The Rule Set constructed by a Rule Set Builder is intended to be an open-ended structure that supports any kind of structure, functionality, behavior, and state that may be constructed by other Builders.

The Rule Set Builder has a set of BuilderInputs that it uses to configure its behavior in constructing the System Logic Object. These inputs include (but are not limited to) the following:

TABLE 2

| Input name | Function |
|---|---|
| Name | The name of the rule set. |
| Phases | A set of names to represent the values of a phase variable. The Rule Set |
| | Builder optionally constructs an action associated with each phase. |
| | When called, each of these actions sets the state of the operating system |
| | logic object to a particular phase, optionally resets the executed state of |
| | its rules, and triggers continued execution of its rules. |
| Bound | A set of externally defined structures, to which the rule set has access |
| Variables | for reference purposes. Bound variables can be referenced in rule |
| | patterns, and actions defined by the system logic object can change the |
| | state of variable values, as well as reference these values. |
| Bound | A set of externally defined actions that can be called by other actions |
| Actions | defined in a system logic object, including rules. Service calls are a |
| | particular type of action, which call a service with a set of pre- |
| | configured input values. For example, a service call could be a call to a |
| | SOAP/WSDL (Simple Object Access Protocol/Web Services |
| | Description Language) web service, with a set of pre-configured input |
| | values. |
| Option to Build | A parameter that indicates whether or not the Builder should construct |
| OnLoad | the OnLoad action in the system logic object. This action is performed |
| | automatically when a system logic object is executed by a computing |
| | system. The OnLoad action sets the phase to an initial value, and |
| | executes any rules that match at this phase. |
| Default | The default action to be performed whenever the system logic object is |
| Action | set to a phase, executed, and no other action is performed. This default |
| | action is often set to be the return of a block of data in the form of an |
| | HTML page, or an XML structure. |

The Rule Set Builder is not limited to these input parameters. Other parameters can be added to the Builder that prescribes the overall operating behavior of the system logic object. For example, it is possible for a system logic object to operate by entering an infinite loop where rules are firing constantly, versus operating behavior where the system logic object executes a set of rules, stops, and then is set to another phase, where it executes more rules, and stops once again.

A Rule Set Builder can have optional BuilderInputs for specifying the name of an initial Action to call when a Rule Set is executed. This is known as the Initial Behavior. If such a BuilderInput value is supplied, then the Builder constructs a Simple Rule whose Behavior contains a Condition Test in the form of:

if (OnLoad( )) { }, whereby OnLoad represents a method call to an action that returns a Boolean value indicating whether or not the computing system is at an initial state (only realized once during execution), Furthermore, the Builder creates an Action Call to the specified Action, and inserts this into the Simple Rule's Behavior.

Another example of an Initial Behavior for a Rule Set is:

if (Onloado( )) { setPhase(“start”); }, whereby setPhase (“start”) is an Action Call to an Action that sets the Phase Variable of the Rule Set to the value “start”.

It must be noted that it is not necessary for the Rule Set Builder to have BuilderInputs for specifying Bound Variables, Bound Actions, a Default Action, or an OnLoad parameter.

In order to use a Rule Set Builder, the user of the present invention creates a Generative Model using the interactive authoring application (e.g. Designer) and selects to add a Rule Set Builder call to the Generative Model. The application opens the Builder Editor user interface of the Rule Set Builder and obtains the set of input values to the Builder parameters. Then, upon receiving an “OK” signal from the user interface, the application adds a new BuilderCall to the Generative Model, and then invokes the regeneration function of the new Builder, and this produces a set of updated System Logic Objects in the Generative Container of the Generative Model. The Generative Model can also contain any number of previously added BuilderCalls. The Generative Container can contain any number of previously constructed entities, including other System Logic Objects.

FIG. 12 illustrates a graphical representation of example System Logic Object (Rule Set) created by a simple Rule Set Builder. Rule Set (48) containing four phases: start phase (49), run phase (50), done phase (51), and reset phase (52). In addition, there is an OnLoad function (53) that sets the state of the phase to start, and triggers execution of a start rule (54) that executes page processing to prepare and send back page1 (55). All of the shown entities of the System Logic Object are created by a single instance of a call to a Rule Set Builder.

Phase Builder

A Phase Builder is a System Logic Builder that modifies the allowed values of a Phase of a Rule Set. The Phase Builder has BuilderInputs for specifying 1) the Referenced Rule Set, and 2) the criteria for modifying the values of said Phase. The second BuilderInput can accept a name of a new Phase value, and a criteria for where to insert it into the set of existing enumerated values. An example usage may have the user add a Phase Builder to the Generative Model after a RuleSet Builder to alter the Phase in the generated RuleSet.

Base Rule Builder

The Base Rule Builder creates a behavior in a system logic object in the form of a rule called a Base Rule.

In many programming languages, a rule is expressed as an if-then expression, as follows.

If (pattern A) {then perform action B;

}

There are many ways of expressing rules. For example, a table can be a way to define a set of rules indirectly, whereby an entry in the first cell of a row is a rule's pattern, and another cell of the same row is the rule's action. The point here is not to elaborate on all the different ways of expressing rules, or behaviors, nor is it the point to elaborate on the different ways of expressing patterns or actions. Instead, the point is to identify that a behavior can be expressed in a system logic object in the form of a rule. Therefore it is possible for a Builder in the present invention to construct a new behavior, modify an existing behavior, or delete a behavior, all in the context of a system logic object.

Base Rule Builder Inputs

The Base Rule Builder has a set of BuilderInputs for specifying 1) the Test Condition, 2) the Action Calls associated with the Then Behavior, 3) the Action Calls associated with the Else Behavior, and 4) the “Pre Condition” to be used to determine whether or not the Test Condition should be evaluated at all. Each of the BuilderInputs can take on a degenerate value, meaning “true” in the case of Conditions, and “null” or no action in the case of Action. The behavior of a Base Rule is as follows: a Base Rule executes the Action associated with its Then Behavior if its Test Condition is evaluated to be “true”. Otherwise the Base Rule executes the Action associated with its Else Behavior. The Base Rule Builder also has an input for the name (ID) of the base rule.

The BuilderInputs for supplying the names of Actions Calls can support either the specification of a single Action Call, or a list of Action Calls, which can comprise of zero or more Action Calls. In the latter case, the Builder constructs a new Action comprised of the set of supplied Action Calls. Then, the Builder constructs an Action Call to this new Action. Finally, the Builder associates this Action Call with either the Then or Else Behavior, whichever is relevant.

Following are two examples of how the Base Rule Builder can construct the Action portion of a Behavior in cases where the BuilderInput value for a set of Action Calls is the list: action1( ), action2( ):

If (a>10) {action99 ( );

}

action99( ) {action1( ); action2( );

}

If (a>10) {action1( ); action2( );

}

The BuilderInputs for supplying Test Conditions and Pre Conditions can support either the specification of a single Condition, or a list of Conditions, which can comprise of one or more Conditions. In the first case, the Builder constructs a Condition Test that evaluates the single Condition. In the second case, the Builder constructs a Condition Test that evaluates all of the Conditions with logical AND's.

Following is an example of how the Base Rule Builder can construct the Condition Test portion of a Behavior in cases where the BuilderInput value for a set of Pre and/or Test Conditions is the list (a>5), (b>10):

if ( (a>5) && (b>10) ) {}

Listed below is an example of a behavior, expressed in the Java language.

Case 1

if (a>0) {action1( );

}

Following is an example of two behaviors, where the second behavior has a condition, which is the negative of the condition of the first behavior. This is the familiar if-then-else behavior.

Case 2

if (a>0) {action1( );

} else {action0( );

}

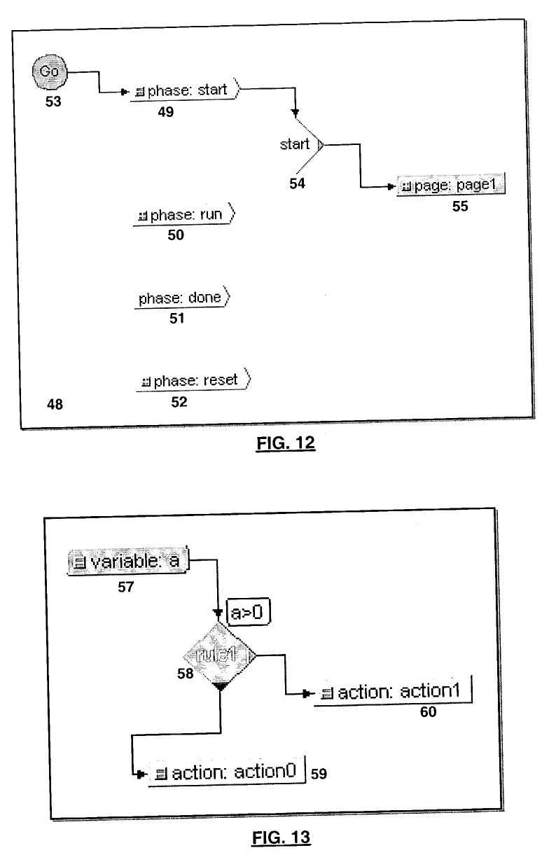

FIG. 13 shows a graphical representation of Case 2 expressed in the rule format. Base Rule (58) (rule1) has a condition (57) and two actions (59) and (60). Again, a Base Rule can have any patterns representing its pre and test conditions, and any two actions. In addition, a Base Rule may also have no action or actions associated with the then and else cases.

The Base Rule Builder also has optional inputs for associating the behavior with a “from” state, and a pair of “to” states associated with the “then” and “else” cases. By specifying “from” and “to” states via the Builder Input parameters, the user supplies the Builder with information that enables it to construct additional patterns in the base rule conditions that ensure that the computing system possesses the from state in order to activate the behavior and cause either the “then” or “else” actions to execute. By specifying a “To” state for either or both of the “then” and “else” cases, the Builder adds Action Calls to Actions, which change the state of the computing system to those called out by the specified states. These states are called “phases” in the example Builder. Note, that the implementation of phases is not required in the Base Rule Builder.

```
Case 3
If (phase == RUN) {
  if (a>0) {
    action1( );
    phase = DONE;
  } else {
    action0( );
    phase = RESET;
  }
}
```

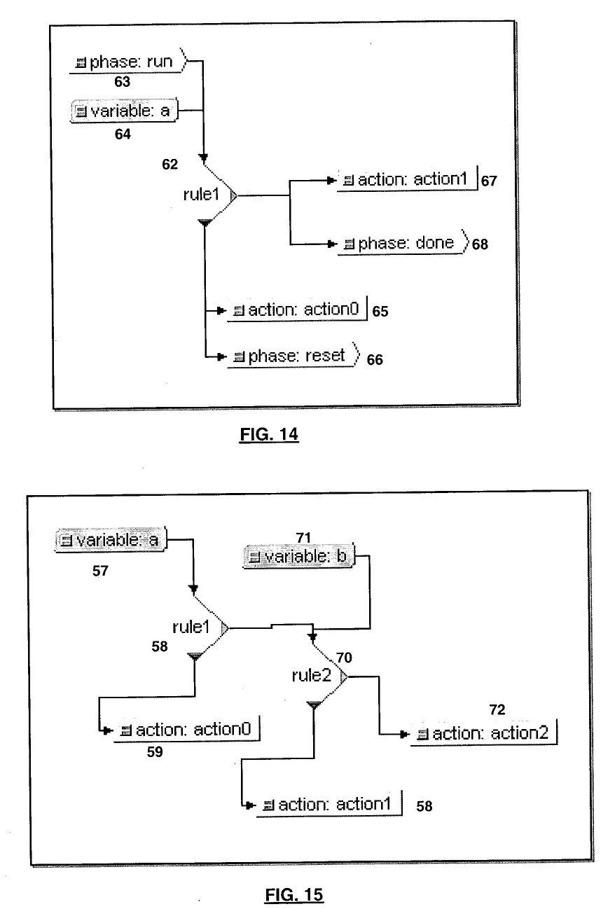

Case 3 shows one of many ways in which a Base Rule can have additional patterns and actions that cause it to exhibit additional behaviors. Here, the Base Rule is able to activate if the phase is at a RUN state. If it is, then the conditions are checked, and the then or else actions may execute. In addition, the rule causes the phase to change to RUN, or RESET. FIG. 14 shows the corresponding Base Rule 62 (rule1), which has conditions (63) and (64). Note that condition (63) is a phase check. Once the conditions are checked, then either action (65) and (67) is executed, along with the appropriate phase setting mechanism (66) or (68).

The Base Rule Builder has an optional input called: Fire Once Before Reset, which can be set to true or false. This Builder Input causes the Builder to determine whether or not to construct additional conditions and actions in the rule that govern the rule's ability to fire multiple times before the state of the entire system logic object has been reset. If a rule is able to fire multiple times, then the computing system will execute the rule as many times as it needs to, as long as the patterns match. If the rule is set up so as to only fire once, then when it fires once, the computing system changes the state of the operating system logic object to reflect this state. The change causes the rule not to fire again until its “fired” state has been reset.

An example of a rule that might fire many times is one that adds a value to a variable repeatedly. An example of a rule that might fire once and be disabled until a reset of the whole system is one that computes the discount of a price, where the price is a value maintained by a variable.

Implementation Independence of Generated Representation

It is important to note that the Builders of the present invention are able to generate System Logic Objects in any source representation. In Case 3 above, a Java representation of the generated output for the Base Rule Builder is illustrated. In the following example, the same behavior is expressed as two rules, where the target computing system is a software object that operates the ILOG Inference engine called JRules from ILOG Corporation. The Base Rule Builder generates this representation using the same parametric Builder inputs that are used to generate other representations of the same system behavior.

```
rule rule1Else {
  when {
    ?aVariable:Variable(name.equals(“a”);
  ?a:intValue; );
    ?rule1ElseRule:Rule(?ruleName:name;
  ?ruleName.equals(“rule1Else”); notFired( ); );
    evaluate(!(a>0));
    ?rs1Phase:Phase(?phase:value;
  ?phase.equals(“run”));
  } then {
    modify refresh ?rule1ElseRule { setFired( );
  setActive( ); };
    modify refresh ?rs1Phase { set(“reset”); };
    callAction(“action0”);
  }
};
```

Condition Types

The Base Rule Builder is one of a number of Builders in the invention that supports the creation of any kind of expression that evaluates to a true or false state. However, in the present invention, there are a number of pre-built test expressions that the user can employ in constructing the conditions for the input to a Base Rule Builder, or any of the other Builders that supports construction of conditions. These pre-built expressions test for the states of other entities in the system logic object. A list of such expressions tests is offered below. This is not a complete list, but is intended to show what types of conditions that are supported by the Builders that create conditions.

variableStatus(String variableName, int status);

actionStatus(String actionName, int status);

junctionStatus(String junctionName, int status);

serviceStatus(String serviceName, int status); and,

ruleStatus(String ruleName, int status);

The values for status include, but are not limited to the following: FIRED, ARMED, ACTIVE, NOTFIRED, DISABLED, SUCCESS, FAIL, WORKING, WAITING. Using the expressions listed about, a Condition can check the status of a Variable, an Action, a Junction, a Service, or a Rule. System Logic Objects generated by Builders that make use of these Conditions can thus direct the flow of the System Logic accordingly.

Action Types

Builders that create Actions can also utilize a number of pre-built Actions that reference entities constructed in the system logic object by other Builders. An example collection of such Actions is offered by the following list.

callService(String serviceName);

callAction(String actionName);

callMethod(String methodName);

setVariable(String variableName, Object value);

setStatus(Object object, int status);

returnObject(Object object);

setPage(String pageName);

As shown in the list a Service, an Action and a Method can be called as part of a pre-defined Action. Also a Variable, a Status and a Page can also be set. An object can be retrieved also as part of an Action.

Chain Rule Builder

A Chain Rule Builder is a System Logic Builder that both adds a new Rule, and modifies the structure of an existing Rule. Prior to modifying an existing Rule, a Chain Rule Builder first constructs a new If-Then-Else Rule. In one embodiment of the present invention, the existing Rule is referred to as Rule1 and the new If-Then-Else Rule is referred to as Rule2. Next, the Builder replaces one of either the Then or Else Action portions of referenced Rule1 with the new Rule2. Next, it inserts the original Then or Else Action portion of referenced Rule1, into the new Rule2's Else Action. The Chain Rule Builder has BuilderInputs for specifying 1) the Referenced Rule, referred to here as Rule1, 2) the Target Action, referred to here as either the Then or Else Action portion of Rule1, 3) the New Rule's Test Condition, and 4) the new Rule's Then Action Calls.

Consider the following example where the user specifies the following values for BuilderInputs relative to a System Logic Object (i.e. Rule Set) already containing Rule1:

BuilderInput Values:

| | | |
|---|---|---|
| 1) | Referenced Rule | Rule1 |
| 2) | Target Action | “Then” |
| 3) | New Condition(s) | (b>2) |
| 4) | New RuleAction Calls | action2( ); |

Prior to regeneration of the Chain Rule, the System Logic Object contains the following structure:

Rule1

if (a>0) {action1( );

} else {action0( );

}

The steps of regeneration of the Chain Rule are as follows: First, the Chain Rule Builder constructs a new Rule, referred to as Rule2 which is as follows:

New Rule2

If (b>2) {Action2( );

} else {}

Next, the Chain Rule Builder replaces the “Then” Action portion of Rule1 with the new Rule2 as follows:

```
if (a>0) {
  If (b>2) {
    action2( );
  } else {
  }
} else {
  action0( );
}
```

Finally, the Chain Rule Builder inserts the original Then Action portion of Rule1 into the Else Action of new Rule2 as follows:

```
Case 4
if (a>0) {
  If (b>2) {
    action2( );
  } else {
    action1( );
  }
} else {
  action0( );
}
```

FIG. 15 is a graphical illustration of Case 4. FIG. 15 shows a Chain Rule called rule2, which is associated with the referenced Base Rule called rule1 (first shown in FIG. 13). Notice the differences between FIG. 13 and FIG. 15. In FIG. 15, Chain Rule rule2 (70) is added in the old position of action1 (60). Chain rule rule2 (70) checks variable “b” (71) and has two actions: action1 (60) and action2 (72). In other words, if the conditions for rule1 (58) are met, then rule1's “then” action is executed, meaning that rule2 (70) is activated. When a Chain Rule has been activated, it has the ability to fire its “then” action if its conditions are met, and its “else” action if it's conditions are not met. In the case above, if the conditions for rule2 (70) are met, then action2 (72) is executed. If rule2 (70) has been activated, but its conditions are not met, then the action originally specified by rule1's “then” case is executed. This action is action1 (60).

It must be noted that if the second BuilderInput (the Target Action—“Then”) to the Chain Rule Builder above is changed to reference the “Else” portion of Rule1, and the Builder is regenerated, then the System Logic Object updates to look like the following:

```
if (a>0) {
  action1( );
} else {
  If (b>2) {
    action2( );
  } else {
    action0( );
  }
}
```

In summary, a Chain Rule has the effect of changing the original behavior of the referenced Rule, such that if the referenced Rule's if-then condition is met, then the “then” action of the referenced Rule is not performed. Instead, the action of the referenced rule is to trigger activation of the Chain Rule.

There are many different ways by which a Chain Rule can activate another object. In one embodiment of the present invention, the referenced rule calls a setActive( ) method on the Chain Rule. For example, in the case above rule1 would call a setActive( ) on rule2. The Chain Rule Builder adds the setActive( ) call to the existing referenced rule as part of modifying the actions of the referenced rule.

Full Path Name

The Chain Rule Builder has an additional BuilderInput called Full Path Name, which is hidden from the user. The value of this BuilderInput is supplied and updated by the Chain Rule Builder's Coordinator (recall FIG. 7A) logic automatically, whenever the user specifies values for the first two BuilderInputs—the Referenced Rule, and the Target Action. When the user specifies a Referenced Rule and a Target Action, the Coordinator logic determines if the Referenced Rule is nested within the Action of another Rule, and if so, whether or not that Action is part of another Rule that is nested within the Action of yet another Rule, and so forth. When this analysis is complete, the Coordinator logic constructs a value for the Full Path Name BuilderInput which is a concatenation of Rule/Action statements of all the nested Rules found in the analysis, beginning with the last one first. Following is an example of the value that would be derived by the Coordinator logic would for the Full Path Name hidden Builderlnput.

Going back to our Case 4 example, we have:

```
if (a>0) {
  if (b>2) {
    action2( );
  } else {
    action1( );
  }
} else {
    action0( );
}
```

If the user supplied the following BuilderInput values,

| | | |
|---|---|---|
| 1) | Referenced Rule | Rule2 |
| 2) | Target Action | Then |

Then the Full Name Input value would be

Rule1/Then, Rule2/Then.

The Chain Rule Builder uses the value of the Full Path Name in its Regeneration logic in specific cases when one of the other BuilderInput values cannot be used. This happens in cases where a Builder's Regeneration function tries to resolve the value of a BuilderInput, and that value is actually the name of an entity in a DomainObject that may, or may not exist. In some cases, the Regeneration function may have a value for a BuilderInput, but it may not be able to find the referenced object in the DomainObject, for whatever reason. This can prevent the Regeneration function from completing its regeneration tasks. With the Chain Rule Builder, in some cases, the Referenced Rule may not actually exist, even though a value exists for the Referenced Rule BuilderInput. This can happen in situations where a Generative Model is created with multiple Chain Rule Builders that reference the Rules created by each other—forming Rule Chains. In this case, if such a Generative Model is subsequently regenerated with one of the Chain Rule BuilderCalls “disabled” in the BuilderCallList, it can cause Chain Rule BuilderCalls existing later in the BuilderCallList to fail to find the Rule(s) that it is referencing. This is when the Chain Rule Builder resorts to using the Full Path Name BuilderInput to find the next available Rule in the Chain that it can reference. A more detailed description of this process is given in the “Automatic Reference Adaptation” section

Multiple Chain Rules

The Chain Rule Builder can also build a Chain Rule that references another Chain Rule. This enables a Base Rule Builder and a set of Chain Rule Builders to construct an N-level deep nested chain of behaviors in the system logic object. In the following case, a Chain Rule Builder is added to the Generative Model, which causes the addition of a Chain Rule that references an already existing Chain Rule in the system logic object. The effect of adding the second Chain Rule is to alter the behavior of the referenced Chain Rule, while preserving the behavior of the Base Rule. An example case is presented below. We start with where we left off in Case 4.

```
if (a>0) {
  if (b>2) {
    action2( );
  } else {
    action1( );
  }
} else {
    action0( );
}
```

After a new Chain Rule BuilderCall has been added to the Generative Model, with the following BuilderInputs:

| | | |
|---|---|---|
| 1) | Referenced Rule | Rule2 |
| 2) | Target Action | Then |
| 3) | New Condition(s) | (c>3) |
| 4) | New Action Call(s) | action3( ); |
| 5) | Full Path Name | Rule1/Then,Rule2/Then |

we have:

```
Case 5
if (a>0) {
  if (b>2) {
    if (c>3) {
      action3( );
    } else {
      action2( );
    }
  } else {
    action1( );
  }
} else {
  action0( );
}
```

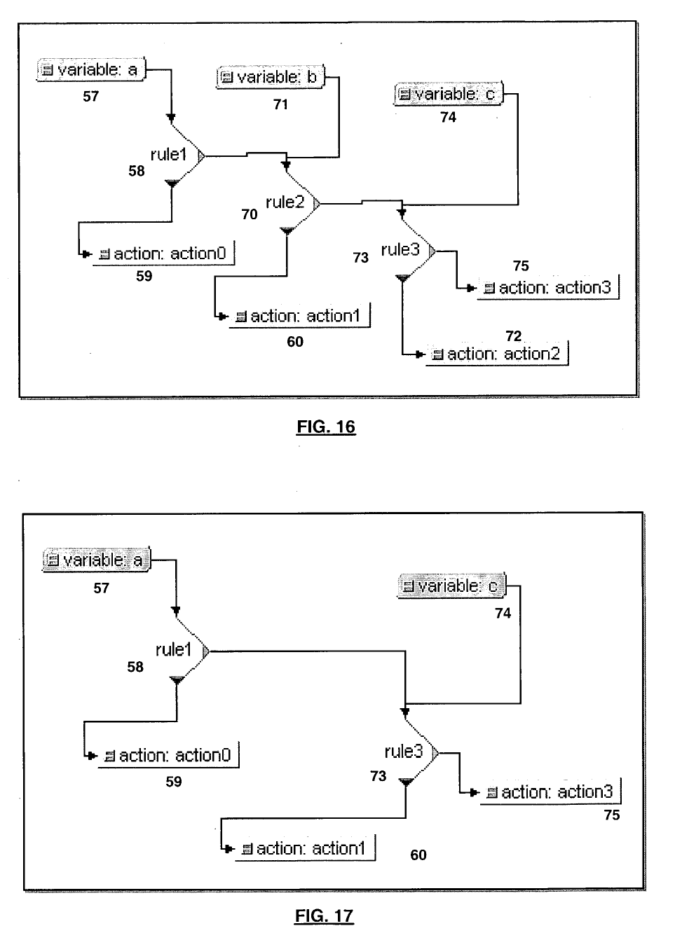

FIG. 16 is a schematic diagram showing the flow of Case 5 after the addition of the second chain rule. Compared to FIG. 15, the addition of rule3 has changed the flow of the logic. Now Chain Rule rule3 (73) is in the old position of action2 (72). Chain Rule rule3 checks variable “c” (74) and has two actions based on the outcome of the checking of variable “c”: action3 (75) and action2 (72). It must be noted that the Chain Rule progression needs not to be linear. A “tree” progression is possible. A Rule can have multiple Chain Rules associated with it. This enables the user to construct chain rule trees in the system logic object.

Automatic Reference Adaptation

The present invention enables a user to disable any Builder in a Generative Model. This causes the system to regenerate only the active Builders in the Generative Model (skipping over the disabled Builders) and produce a new set of generated objects, including the system logic object. In Case 5 above, the full path of the chain is “Rule1,Then/Rule2,Then.” If the Rule corresponding to this value is not found in the generated system logic object, then the Chain Rule's regeneration function looks at the full path name input, and finds the “lowest” Rule in the chain that is present in the generated System Logic Object (Rule Set). For example, if the user disables the Chain Rule Builder that constructs Rule2, then the Chain Rule Builder that constructs Rule3 would alter its behavior and associate the constructed Rule3 with Rule1 instead of Rule2. This is because the lowest rule is not Rule2, but Rule1 (Rule2 has been disabled). Case 6 illustrates the effect of disabling the first Chain Rule Builder in the Generative Model.

Case 6

First Chain Rule for rule2

```
Is disabled
if (a>0) {
  if (c>3) {
    action3( );
  } else {
    action1( );
  }
} else {
    action0( );
}
```

FIG. 17 is a schematic diagram showing the flow of Case 6. Note the differences between FIG. 16 (Case 5) and FIG. 17 (Case 6). The progression now goes from rule1 (58) to rule3 (73). The location of action1 (60) has now moved to after rule3 (73).

In building case 6, the last Chain Rule Builder was unable to find its original Referenced Rule—rule2, characterized by the condition (b>2). As a result, the Chain Rule Builder's regeneration function resorted to the Full Path Name to find the next available Referenced Rule in the “chain”. It found that Rule1 was next in line above Rule2 in the chain, and so it used Rule1 as the value for the Referenced Rule BuilderInput value. Thus the Chain Rule Builder constructs Rule3 with an attachment to Rule1. As a result, the Chain Rule Builder constructed its new rule

if (c>3) { action3( ); } else { }

inserted it into Rule1's “Then” Action. Then the Chain Rule Builder removed Rule1's “Then” Action and assigned it as the “Else” Action of the new Rule.

This BuilderInput value reassignment capability enables Builders such as the Chain Rule Builder to have powerful adaptive capabilities in cases where the DomainObjects in the GenContainer may have changed significantly, from one regeneration of the Generative Model to the next. This capability is referred to as Automatic Reference Adaptation.

In general, a Builder of any type can automatically adapt its own generative behavior, as long as the input whose value references a missing entity in the System Logic Object has a backup input that specifies a fallback reference. This approach is used in the Chain Rule Builder. However, sometimes it is desirable for a Builder to signal an error in the regeneration process when a missing entity is referenced.

The behavior of the automatic adaptation is summarized by the flow chart in FIG. 18. In step 176, a new Chain Rule Builder is added to an existing Generative Model. Then in step 177, the regeneration function is run. In the course of regeneration, the system will try to find the rule that is referenced by the newly added Chain Rule Builder (step 178). If such a rule is found, then in step 179 the new Chain Rule is attached to the referenced rule. Otherwise in step 180 a lookup is performed on the full path of the existing chain and the new Chain Rule is attached to the lowest rule in the path.

In the present invention, the referencing mechanism can be applied to adaptation of references other than rule references. In general, it can be applied to any reference that may need a backup reference. One can think of the Builder input that holds the primary reference as the “strong” Builder input, and the Builder input that holds the backup reference as the “weak” Builder input.

Rule Action Builder

A Rule Action Builder is a System Logic Builder that modifies the Action Call portion of the Behavior of a Referenced Rule or set of Rules. The Builder constructs one or more new Action Calls, and inserts them into the Action portion of the Behavior of the Referenced Rules.

The Rule Action Builder has BuilderInputs for specifying 1) the Referenced Rule or Rules, 2) the “Then”, “Else”, or both Action portions of the Referenced Rule(s), into which the new Action Calls should be inserted, and 3) the set of Actions, for which Actions Calls should be constructed and inserted into the Referenced Rule(s).

The Rule Action Builder can also add Action Calls to referenced Actions. The BuilderInput for supplying the names of Referenced Rules can accept names of Actions.

The Rule Action Builder can have an optional BuilderInput for specifying whether the inserted Action Calls should be inserted at the beginning or end of the referenced Action.

Following is an example of how a Rule Action Builder would modify a set of Referenced Rules:

Rule1:

If (a>5) {action1( );

}

Rule2:

If ((b>10) ∥ (c<30)) {action2( );

}

with BuilderInput values for Rule Action Builder

| | | |
|---|---|---|
| 1) | Referenced Rule(s) | Rule1, Rule2 |
| 2) | Target Action | Then |
| 2) | New Action Call(s) | action3( ); |

The rules after applying the regeneration function of the Builder are as follow.

Rule1:

If (a>5) {action1( ); action3( );

}

Rule2:

If ((b>10) ∥ (c<30)) {action2( ); action3( );

}

Thus, action3( ) is added to both referenced Rules, namely Rule1 and Rule2. The Rule Action Builder adds one or more actions to a set of rules, actions, and junctions in a system logic object. The Builder provides a set of parametric inputs for specifying to which entities to apply the actions. The Builder's generation function uses these input values to determine how to evaluate the system logic object, and select the entities that will have the new actions added. The Rule Action Builder also has an input for specifying the list of actions to be added to the target entities. Using the Rule Action Builder, the user can construct the same types of actions that are available in the Base Rule and Chain Rule Builders.

Indirect Referencing

The effect of disabling a Rule Action Builder call in a Generative Model causes the regeneration function of the Rule Action Builder to be disabled, so that it does not build the specified actions in the affected Rules, Actions, and Junctions. In addition, it is also possible to specify the target entities in a Rule Action Builder's input parameters without naming specific entities. One way of doing this is to specify that the Rule Action Builder add its actions to all Rules with a particular “From Phase”. The use of a “From Phase” causes the Rule Action Builder to have flexibility in the way it finds the target entities (where to add the action). This flexible behavior also makes it possible for users to disable BuilderCalls preceding a Rule Action BuilderCall in a Generative Model, which in turn, eliminates the construction of certain Rule, Action, and Junction entities, which in turn, causes the Rule Action Builder to automatically adapt its behavior in constructing actions in relevant entities present in the currently generated system logic object. For example, consider a Rule Action BuilderCall is specified to add actions to Rules with a particular “From Phase.” In one regeneration, three generated Rules may fit this criteria and the actions are added to the three Rules. However in the next regeneration, one of the Rule Builder may be disabled and the Rule Action Builder will only add actions to the remaining two Rules.

Indirect referencing is a functionality in the present invention that enables a Builder input to have a value that resolves to a set of referenced entities. Such a value can be in the form of any expression that resolves to a set of referenced entities. Because this resolution function takes place during the regeneration of the Builders that are called in a Generative Model, the result of the resolution function can change from regeneration to regeneration.

For example, one way of referencing rules is to provide a list of Rule names as the value in a Builder input. The list is a direct reference to entities in a System Logic Object. Thus when a Builder input expects such a list, it is using direct reference. In contrast, if a user supplies a value in the form of an indirect reference (e.g. “From Phase”), then this reference resolution is deferred until the point of regeneration, which occurs when regeneration of the Builder takes place. If the user supplies an indirect reference in the form of ${rulesAtAPhase (“phaseX”);}, then the Builder will take this value and resolve it to the list of rules as part of its generation function. In this case, “phaseX” is not known until regeneration and its resolved value can change from one regeneration to the next. Thus, the next time regeneration takes place, there may be a different set of rule objects associated with “phaseX” than the set present at the time when the user created the Builder call in the Generative Model.

The Rule Action Builder in the present invention provides three different ways of specifying the target rules for creating actions. The three ways are listed below. This list is not all-inclusive, but is included to illustrate the variety in ways in which a Builder can have indirect references specified through input values:

List of Rules A list of rule names in a system logic object (direct referencing)

Rules at a Phase The name of a phase in a system logic object (indirect referencing)

Rules in a Chain The name of a Chain Rule in a system logic object, which represents the end of a chain (indirect referencing).

The first two items of this list have been discussed already. The third, which specifies Rules in a Chain as an input, is an indirect reference that works similarly to the Rules at a Phase input. The only difference is that the resolution is now based on a Chain Rule value instead of a Phase. The Rule Action Builder also has inputs for specifying whether actions should be applied to the “then”, “else”, or both portions of the rule, and whether or not junctions and actions should be included. Furthermore the Rule Action Builder also has an option for specifying that all the rules except for the ones specified should be considered to be the targets.

Rule Condition Builder

A Rule Condition Builder is a System Logic Builder that modifies the Condition Test portion of a Referenced Rule or set of Rules. The Builder constructs one or more new Conditions, and inserts them into the Condition Test portion of the Behavior of the Referenced Rules. The approach used to insert the Conditions involves taking the original Condition, and concatenating the new Conditions with logical “AND” operators. This produces a new Condition.

The Rule Condition Builder has BuilderInputs for specifying 1) the Referenced Rule or Rules, and 2) the set of Conditions to be inserted into the Referenced Rule(s).

Following is an example of how a Rule Condition Builder would modify a set of Referenced Rules:

Rule1:

If (a>5) {action1( );

}

Rule2:

If ((b>10) ∥ (c<30)) {action2( );

}

and the following BuilderInput values for Rule Condition Builder

1) Referenced Rule(s) Rule1, Rule2

2) New Condition(s) (d<100)

The Rules after applying the regeneration function of the Builder would be:

Rule1:

If ((a>5) && (d<100)) {action1( );

}

Rule2:

If (((b>10) ∥ (c<30)) && (d<100)) {action2( );

}

Thus, the Condition (d<100) has been inserted into the referenced Rules, namely Rule1 and Rule2. The Rule Condition Builder is very similar to the Rule Action Builder, except that this Builder constructs additional conditions in a set of target rules, rather than additional actions. Like the Rule Action Builder, indirect referencing is an option for the input in the Rule Condition Builder.

Action Builder

The Action Builder constructs an action in a System Logic Object that is comprised of a set of calls to functional entities, including other Actions. In the Action Builder, the user can construct the same types of calls to functional entities that are available in all other Builders that support the construction of action call sequences.

The Action Builder has an input for specifying the name of the Action and an input for specifying the set of Actions to be called. The Builder allows individual Action calls to be specified as asynchronous or synchronous. It is also possible for a set of action calls to be specified as a mix of these options. In this case, the behavior of the action upon execution is to call the actions in the order specified in the Action call sequence, and wait for completion if an action call is specified as synchronous.

The Action Builder is designed to dynamically generate many properties of the action during the regeneration of the Builders in a Generative Model. The regeneration behavior of the Action Builder can be altered by changing its parametric input values prior to regeneration. It is possible for the Action Builder to change the order of the Action calls that it constructs, as well as change the calling properties of each Action call from asynchronous to synchronous. In addition, the Action Builder can construct behaviors associated with the action that govern and update the state of the Action in the System Logic Object.

For example the user can specify via the Action Builder's input parameters that the generated Action have a behavior whereby the action will get marked as complete when the first called sub-action obtains a successfully completed status. The Action Builder in the present invention generates this behavior by adding a rule to the System Logic Object that has Conditions that test for the existence of at least one successful sub-action being in a complete state. The Action for this Rule is to then set the state of the System Logic Object to reflect that the Action is now complete.

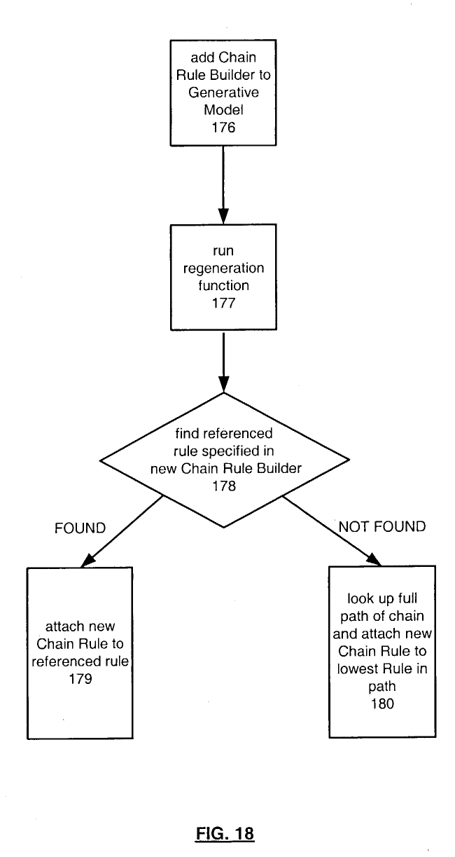

The Action Builder is also able to construct a number of separate behaviors that collectively represent the behavior of the Action and its Action calls. Case 7, along with FIG. 19, illustrate the generated output of an example Action Builder in three different representations. The first example shows a Java representation. The second example shows a schematic representation (FIG. 19), and the third example shows the behavior in rule language format, suitable for the ILOG rules engine. It is important to note that the Action Builder can generate the behavior in the system logic object in any language that supports the expression of behaviors.

Case 7

```
Example of one of many ways in which
An Action can be expressed
Java
if (action0.isArmed( )) {
  setVariable(b, newValue);
  callAction(“action3”);
  callService(“cis”);
  setPage(“audit”);
  action0.setActive( );
}
ILOG
rule action0 {
  when {
    ?aVariable:Variable(name.equals(“a”);
  ?a:intValue; );
    ?bVariable:Variable(name.equals(“b”);
  ?b:doubleValue; );
    ?action0Action:Action(?ruleName:name;
  ?ruleName.equals(“action0”);armed( ););
  } then {
    setVariable(?bVariable, a*100);
  callService(“cis”);
    callAction(“action3”);
    setPage(“audit”);
    modify refresh ?action0Action { setFired( );
  setActive( ); setDisArmed( ); };
  }
};
```

FIG. 19 illustrates a graphical representation of the Action (76) in a System Logic Object, created by the Action Builder. The generated Action is comprised of calls to other units of functionality. In this diagram, each call also has a link to an object that represents the object, operated upon by the Action.

Junction Builder

The Junction Builder constructs a Junction in the System Logic Object. The steps of filling in the Builder inputs are similar to those for filling in the Condition inputs for a Base Rule Builder, with the exception that the user also specifies whether the junction is an AND, OR, NAND, NOR and XOR type junction. In one embodiment the present invention, the Junction Builder supports the AND and OR cases.

In the present invention, a Junction is implemented as a special type of rule, which operates on a Junction object. The Junction object maintains the state information of the junction, whereas the junction's rule behavior is set up so as to fire when the conditions of the junction are met. When the Junction Rule executes, it sets the status of the Junction object to reflect an active state. Other behaviors in the System Logic Object can reference the status of a Junction in their Conditions. The following example code illustrates one implementation of Junction logic in a System Logic Object. This code was generated by the Junction Builder.

rule junction1 {

when {

?cisServiceOutput:ServiceOutput(name.equals(“

cis”); ?cis:value; );

?action2Action:Action(name.equals (“action2”);

);

?action3Action:Action(name.equals(“action3”);

);

evaluate(?action2Action.active( ) ∥

?cisServiceOutput.active( ) ∥

?action3Action.active( ) ∥

?junction1Junction:Junction(?ruleName:name;

?ruleName.equals (“junction1”)

notFired( ); );

} then {

modify refresh ?junction1Junction {

setFired( ); setActive( ); };
}

};

Alternatively, the Junction Builder can generate other source representations of Junction behavior in languages that support the expression of this type of behavior. For example, the Junction Builder could produce the following Java representation:

if (serviceOutput(“cis”).active( ) ∥ action2.active( ) ∥ action3.active( ) )

{junction1.setActive( );

}

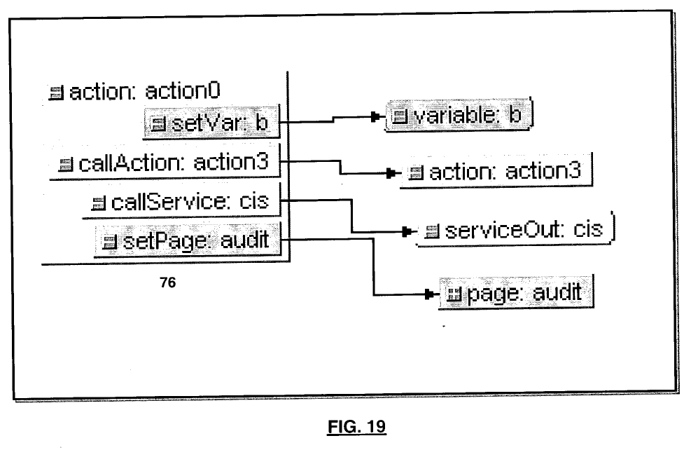

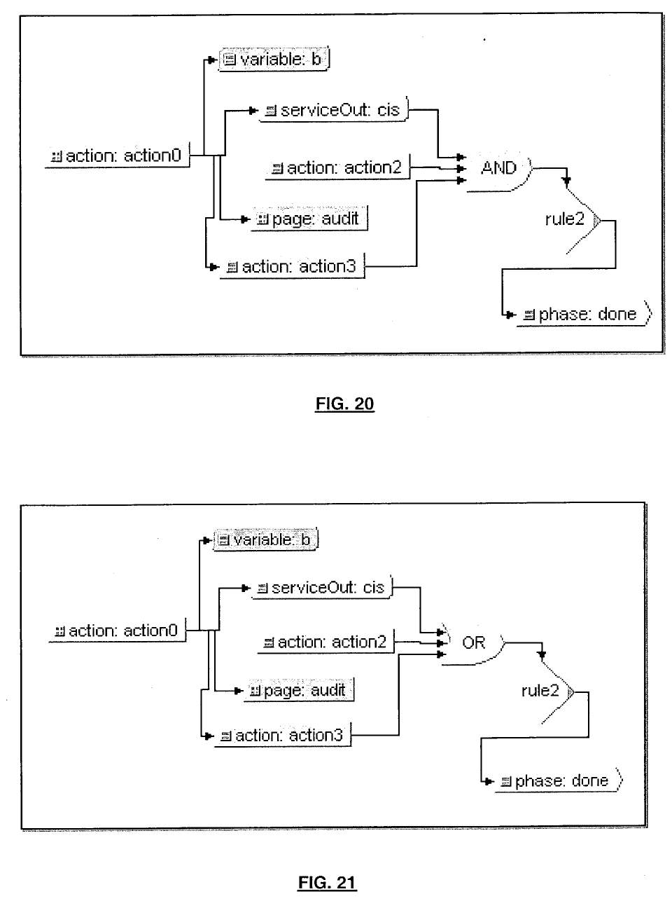

FIGS. 20 and 21 show the result of using Junction Builder on the logic example of Case 7. Using the Junction Builder, an AND-type junction is constructed in FIG. 20. In FIG. 21, the “type” Builder input parameter of the junction is changed in a subsequent regeneration to produce an OR junction. Since the Junction Builder constructs the junction in both cases, so as to have the same name, junction1, the Base Rule Builder that constructs rule2 is able to automatically adapt its construction behavior to attach to the OR junction in the second scenario.

Linked Rule Set Builder

The Linked Rule Set Builder assembles a generated System Logic Object from a referenced Generative Model, into the System Logic Object of the current Generative Model.

The Linked Rule Set Builder has several inputs. The first input is for specifying the name of the referenced Generative Model and the name of one or more Profiles associated with that referenced model that are used to regenerate it. The second input is the name of a current System Logic Object (i.e. Rule Set). Finally there is an input for the local name of assembled System Logic Object generated by the referenced Generative Model. The local name is used when the assembled System Logic Object is placed in the current System Logic Object.

The Linked Rule Set Builder performs its own regeneration task of calling an API on the Regeneration Engine that invokes the referenced Generative Model, regenerates its output objects according to the specified Profile, and returns the generated output objects. At this point, the Linked Rule Set Builder finds the named System Logic Object in the returned output objects, and proceeds to “assemble” it into the System Logic Object of the current Generative Model. This assembly process involves associating the “to be assembled” System Logic Object with a unique name, and constructing data in the current System Logic Object that declares a reference to this “child” object.

Once the user has added a Linked Rule Set Builder call to a Generative Model, it is possible to have Rules and Actions created by subsequent Builders to be set up to call the actions of the child, “assembled” System Logic Object. This includes calling the functions that set the Phase of the child System Logic Object to a certain state. For example, a Base Rule of the parent object could be constructed by a Builder to set the phase of the child object to “Run”. Because of this setting, during the execution of combined assembly of System Logic Objects, when a rule of the parent object fires and sets the child object's Phase to “Run”, all of the Rule behaviors of the child object associated with that Phase to be tested for possible execution.

Notes on All Builders

All of the Builders described in this invention allow the user to create multiple System Logic Objects within a single Generative Model. The present invention also discloses the functionality of a known set of Builders for creating System Logic Objects. The present invention further provides functionality that allows users to create any number of additional Builders that interact with the generated outputs of these Builders or other Builders.

Independence of Language Representation for Generated System Logic Objects

In the present invention, the Builders that construct System Logic Objects are configured to create the representation of the system logic object as a rule set intended for execution in a forward chaining inference engine that supports the Rete algorithm. In one embodiment, the Builders construct references to Java classes in the syntax of the rules. The inference engine loads these Java classes and creates instances of them to represent objects such as Rules, Junctions, Actions, Phases, Variables, etc.

The Builders of the present invention can alternatively generate System Logic Objects and their entities in any language representation that can support the kinds of behaviors, functionality, structure, and state data, expressed in a system logic object. This means that by changing a single parametric input value in one or more of the Builder inputs that collectively construct a system logic object, the Builders can generate the same system logic object in an entirely different language representation. These language representations include compiled languages such as Java, C++, and C#, as well as interpreted languages such as IBM's Web Service Flow Language, Microsoft's XLANG, BEA's XOCP, and high level language tree representations such as Microsoft's Intentional Programming source tree, described earlier.

Usage Scenario Involving “Over Loading” of BuilderCalls in the Generative Model

One powerful way of using the invention that takes advantage of the ability to enable and disable Builders in a Generative Model is called “Over Loading”. Over Loading is the practice of adding multiple BuilderCalls to a Generative Model, whereby some of the Builder inputs are set up in each call, so as to produce generated output objects that have the same names. Consider the following example where two Chain Rule BuilderCalls with the same of “rule2” are created.

The system allows the user to create both BuilderCalls in a Generative Model. Once the user creates both, the user disables one of the BuilderCalls, and enables the other. At any time, only one of the BuilderCalls is ever enabled, which causes there to be no name clashing in the generated objects. If both BuilderCalls were set to enabled, there would be the potential for name clashes, and the Builders would handle this potential error producing scenario.

At this point, the user proceeds to add more BuilderCalls. These Builders can make references to entities in the generated output objects. For example, one could add a Base Rule Builder call, named rule3, and specify through the Builder inputs that the rule should fire only if rule2 is active.

The user can go back and toggle the enabled, disabled status of the two rule2 Chain Rules and the system will build completely different implementations of these rules. Furthermore, the Base Rule Builder that constructs rule3 subsequently will update to make a reference to whichever implementation of rule2 happened to exist.

With a prior art explicit object modeling approach, a user would have to choose between two options: to either create two separate implementations of the desired System Logic Objects, one implementing rule2 one way, the other implementing rule2 the other way, or second, the user could try to build a single object with two rule2's.

The problem with the latter scenario is that the user then has to name the two implementations of rule2 something unique, on order to prevent name clashing. The user could, for example, name the rules rule2a, and rule2b. This approach leads to problems, however, because now there need to be two implementations of rule3, one that references rule2a, and one that references rule2b. The user could create a rule3a, and a rule3b. This construction approach of trying to create a “super object” that implements many different implementations leads to “code explosion.”

The “Over Loading” approach described herein eliminates the necessity of having to create multiple distinct implementations of similar, but different objects, or the need to build large parameterized “super objects” that internally try to implement differing configurations and end up with internal code explosion.

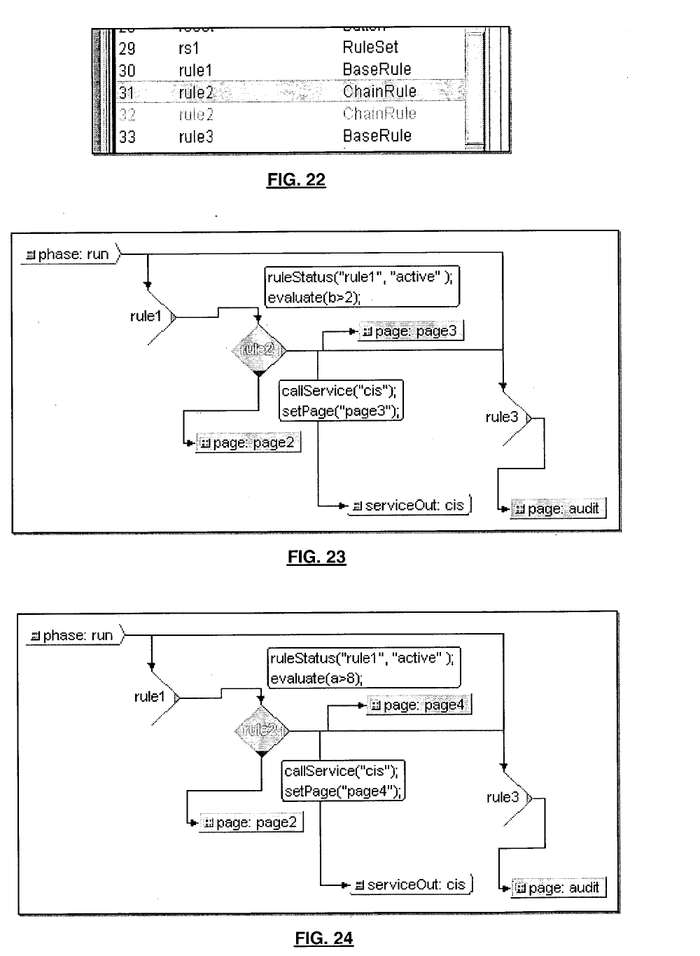

FIGS. 22, 23, and 24 illustrate a Generative Model containing two BuilderCalls to a Chain Rule Builder, each named rule2. FIG. 22 shows an embodiment of the present invention displaying the two instances of rule2, with one highlighted to show that it is enabled and the other dimmed to show that it is disabled. Each Builder call is configured differently to effect the creation of very different rules. In addition, the Generative Model contains a Builder call to a Base Rule named rule3. The user can toggle the enabled and disabled statuses of the two Chain Rule BuilderCalls, and still produce valid implementations of generated System Logic Objects. FIG. 23 shows the first instance of rule2 enabled. FIG. 24 shows the second instance of rule2 enabled.

Conclusion

Thus a method and apparatus for creating system logic is described in conjunction with one or more embodiments. The invention is defined by the claims and their full scope of equivalents.

We claim:

1. A method for creating objects comprising the steps of:
obtaining a generative model; and
processing said generative model to generate said objects.

2. The method of claim 1 wherein said step of processing further comprises the steps of:
finding a plurality of builder calls located in a builder call list in said generative model;
obtaining a profile comprised of a plurality of builder inputs;
creating a generative container to hold said objects as they are created; and
using said builder calls to create said objects in said generative container.

3. The method of claim 2 whereby said step of obtaining a generative model further comprises the step of:
using a generation manager to obtain said generative model.

4. The method of claim 2 wherein said step of using said builder calls further comprises the steps of:
performing regeneration with said generation manager for a first phase using said builder calls; and
repeating said step of performing regeneration for a plurality of phases.

5. The method of claim 4 wherein said step of performing regeneration further comprises the steps of:
using a generative context to obtain a plurality of generative handlers related to said plurality of builder calls in said builder call list; and
executing said plurality of builder calls.

6. The method of claim 5 wherein said step of executing further comprises the steps of:
configuring a subset of said builder calls to be marked as disabled or enabled; and
executing the subset of said builder calls marked enabled.

7. The method of claim 5 wherein said step of executing further comprises the steps of:
processing a first builder call from said builder call list;
using said generative context to initialize a first generative handler related to said first builder call;
initializing a first builder for said first builder call;
invoking the regeneration method of said first builder; and
repeating said steps of processing, using said generative context, initializing a first builder and invoking the regeneration method for said plurality builder calls.

8. The method of claim 7 wherein said step of initializing a first builder further comprises the steps of:
looking up said first builder identified by a builder definition;
obtaining an instance of said first builder by using said set of builder inputs; and
preparing to call said current builder.

9. The method of claim 8 wherein said step of obtaining said first builder requires instantiating a new instance of said first builder.

10. The method of claim 2 further comprises:
creating said generative model.

11. The method of claim 10 wherein said step of creating further comprises the steps of:
using a designer application to create said generative model;
performing a regeneration process with said generative model;
viewing results of said regeneration process; and
optionally editing said generative model.

12. The method of claim 11 wherein said step of using a designer application further comprises the steps of:
instantiating a builder editor in order to create a new builder call;
obtaining a builder definition object and looking up the definitions of builder inputs for a first selected builder call in said generative model;
constructing a plurality of dynamic builder inputs that correspond to said builder inputs; and
instantiating a coordinator function of a builder identified by said first selected builder call.

13. The method of claim 12 wherein said step of instantiating a builder editor instantiates said builder editor in order to modify a second selected builder call in said builder call list of said generative model.

14. The method of claim 12 wherein said step of obtaining a builder definition further comprises the steps of:
obtaining the name of a type of builder to use in constructing a new builder call in said builder call list; and
using said name to obtain said builder definition object.

15. The method of claim 12 further comprises the steps of:
instantiating a set of builder user interface widgets;
setting up said coordinator function;
making said generative container available to said coordinator function; and
saving in said builder call updated dynamic builder input values entered via said user interface widgets.

16. The method of claim 2 further comprises the step of:
creating said profile.

17. The method of claim 16 wherein said step of creating further comprises the steps of:
editing said profile using a customizer application;
performing regeneration with said profile; and
obtaining a second set of generated objects.

18. The method of claim 17 further comprising the step of:
executing said second set of generated objects in an execution engine.

19. The method of claim 2 further comprises the step of:
modifying said plurality of builder inputs in said profile using a customizer application.

20. The method of claim 1 wherein said objects can be serialized.

21. The method of claim 1 wherein said objects are presented in XML.

22. The method of claim 1 wherein said objects are source objects.

23. The method of claim 22 wherein said source objects are in expressed in a programming language.

24. The method of claim 23 wherein said programming language is Java.

25. The method of claim 22 wherein said source objects are expressed in an inference engine rules language.

26. The method of claim 25 wherein said inference engine rules language is the ILOG rules language.

27. The method of claim 22 wherein said source objects comprise a plurality of system logic objects.

28. The method of claim 1 further comprising the step of:
executing said generated objects in an execution engine.

29. A system for creating objects comprising:
a generative model;
a profile;
a regeneration engine;
a plurality of builders; and
a generative container whereby said regeneration engine processes said generative model along with said profile to control said plurality of builders to generate said objects in said generative container.

30. The system of claim 29 wherein said plurality of builders edit said objects in said generative container.

31. The system of claim 29 wherein said regeneration engine further comprises a generation manager.

32. The system of claim 29 wherein said generation manager performs a plurality of phases of regeneration.

33. The system of claim 32 further comprises:
a generative context;
a generative handler;
a builder inputs object; and
a builder definition object.

34. The system of claim 33 wherein said builder definition object further comprises:
a plurality of builder input definitions; and
a plurality of builder group definitions.

35. The system of claim 32 wherein said generative container further comprises:
generative elements that point to a plurality of objects.

36. The system of claim 29 further comprises:
an execution engine; and
an operating application whereby said execution engine executes said objects in said operating application.

37. The system of claim 29 wherein said generative model further comprises:
a builder call list comprising a plurality of builder calls.

38. The system of claim 37 further comprises:
a designer application whereby said plurality of builder calls of said generative model can be edited.

39. The system of claim 38 wherein said designer application further comprises:
a builder call list view;
a generative container view; and
an application view.

40. The system of claim 39 wherein said designer application further comprises:
a builder editor whereby a builder definition is processed to generate a plurality of dynamic builder input for a builder specified by said a builder call in said plurality of builder calls.

41. The system of claim 29 wherein said profile further comprises:
a plurality of builder inputs.

42. The system of claim 41 further comprises:
a customizer application whereby said profile can be edited by a user.

43. The system of claim 41 further comprises:
a customizer application whereby said profile can be created by a user.

44. The system of claim 43 wherein said customizer application further comprises:
a profiles view; and
a profiled application view.

45. The system of claim 29 wherein said objects can be serialized.

46. The system of claim 29 wherein said objects are presented in XML.

47. The system of claim 29 wherein said objects are source objects.

48. The system of claim 47 wherein said source objects are in expressed in a programming language.

49. The system of claim 48 wherein said programming language is Java.

50. The system of claim 47 wherein said source objects are expressed in an inference engine rules language.

51. The system of claim 50 wherein said inference engine rules language is the ILOG rules language.

52. The method of claim 47 wherein said source objects comprise a plurality of system logic objects.

53. A system of generating system logic objects comprises:
a regeneration engine;
a generative model of builder calls;
a profile of inputs;
a plurality of builders whereby said regeneration engine uses said generative model to control said plurality of builders to dynamically generate system logic objects using inputs from said profile.

54. The system of claim 53 wherein said plurality of builders comprise:
a plurality of rule builders;
a plurality of action builders;
a plurality of junction builders;
a plurality of condition builders; and
a plurality of chain rule builders.

55. The system of claim 54 wherein said system logic objects further comprise:
zero or more rules;
zero or more actions;
zero or more junctions,
zero or more phases; and
zero or more structures.

56. The system of claim 55 wherein said plurality of rule builders create a plurality of said rules.

57. The system of claim 56 wherein said rules further comprise a base rule, comprising:
a plurality of conditions;
a first set of zero or more actions in a “then” clause whereby said first set of zero or more actions are executed if said conditions are evaluated to be true; and
a second set of zero or more action in an “else” clause whereby said second set of zero or more actions are executed if said conditions are evaluated to be false.

58. The system of claim 57 wherein said plurality of conditions further comprises a plurality of pre-conditions.

59. The system of claim 57 wherein said base rule can be configured to fire once before reset.

60. The system of claim 57 wherein said base rule further comprises:
a “from” phase condition check;
a first “to” phase in said “then” clause; and
a second “to” phase in said “else” clause.

61. The system of claim 57 wherein a chain rule is attached to said base rule.

62. The system of claim 57 wherein said chain rule is attached to said “then” clause of said base rule.

63. The system of claim 57 wherein said chain rule is attached to said “else” clause of said base rule.

64. The system of claim 57 wherein a plurality of chain rules are attached to said base rule whereby a chain of logical rules is formed.

65. The system of claim 64 wherein said plurality of chain rules are attached using automatic reference adaptation.

66. The system of claim 57 wherein a plurality of chain rules are attached to said base rule whereby a tree of logical rules is formed.

67. The system of claim 66 wherein said plurality of chain rules are attached using automatic reference adaptation.

68. The system of claim 57 wherein said plurality of conditions further comprises a plurality of junctions that logically connect said conditions.

69. The system of claim 55 wherein said plurality of conditions further comprises:
a variable status condition;
an action status condition;
a junction status condition;
a service status condition; and
a rule status condition.

70. The system of claim 55 wherein said plurality of actions further comprises:
a call service action;
a call action action;
a call method action;
a set variable action;
a set status action;
a return object action; and
a set page action.

71. The system of claim 55 wherein said action builders build said actions in said rules.

72. The system of claim 55 further comprises:
zero or more rule set builders;
zero or more phase builders; and
zero or more linked rule set builders.

73. The system of claim 53 wherein said builders can receive indirect references as inputs whereby values of inputs are resolved at time of regeneration.

74. The system of claim 53 wherein said builder calls can have instances with same name whereby overloading can be achieved.

75. A method of generating system logic objects comprising the steps of:
processing a generative model with a plurality of builder calls;
using a profile comprised of a plurality of builder inputs; and
using a plurality of builders specified by said builder calls with said builder inputs to create said system logic objects.

76. The method of claim 75 wherein said plurality of builders comprise:
a plurality of rule builders;
a plurality of action builders;
a plurality of junction builders;
a plurality of condition builders; and
a plurality of chain rule builders.

77. The method of claim 76 wherein said system logic objects further comprise:
zero or more rules;
zero or more actions;
zero or more junctions,
zero or more phases; and
zero or more structures.

78. The method of claim 77 wherein said plurality of rule builders create a plurality of said rules.

79. The method of claim 78 wherein said step of using a plurality of builders further comprises the step of:
building a base rule.

80. The method of claim 79 wherein said step of building a base rule further comprises steps of:
building a plurality of conditions;
building a first set of zero or more actions in a “then” clause whereby said first set of zero or more actions are executed if said conditions are evaluated to be true; and
building a second set of zero or more action in an “else” clause whereby said second set of zero or more actions are executed if said conditions are evaluated to be false.

81. The method of claim 80 wherein said plurality of conditions further comprises a plurality of pre-conditions.

82. The method of claim 80 wherein said base rule can be configured to fire once before reset.

83. The method of claim 80 further comprises the steps of:
building a “from” phase condition check in said base rule;
building a first “to” phase in said “then” clause; and
building a second “to” phase in said “else” clause.

84. The method of claim 80 further comprising the step of:
attaching a chain rule to said base rule.

85. The method of claim 84 wherein said chain rule is attached to said “then” clause of said base rule.

86. The method of claim 84 wherein said chain rule is attached to said “else” clause of said base rule.

87. The method of claim 80 further comprising the step of:
attaching a plurality of chain rules to said base rule whereby a chain of logical rules is formed.

88. The method of claim 86 wherein said step of attaching attaches said chain rules using automatic reference adaptation.

89. The method of claim 80 further comprising the step of:
attaching a plurality of chain rules to said base rule whereby a tree of logical rules is formed.

90. The method of claim 89 wherein said step of attaching attaches said chain rules using automatic reference adaptation.

91. The method of claim 80 wherein said plurality of conditions further comprises a plurality of junctions that logically connect said conditions.

92. The method of claim 77 wherein said plurality of conditions further comprises:
a variable status condition;
an action status condition;
a junction status condition;
a service status condition; and
a rule status condition.

93. The method of claim 77 wherein said plurality of actions further comprises:
a call service action;
a call action action;
a call method action;
a set variable action;
a set status action;
a return object action; and
a set page action.

94. The method of claim 77 wherein said action builders build said actions in said rules.

95. The method of claim 77 further comprises:
zero or more rule set builders;
zero or more phase builders; and
zero or more linked rule set builders.

96. The method of claim 75 wherein said builders can receive indirect references as inputs whereby values of inputs are resolved at time of regeneration.

97. The method of claim 75 wherein said builder calls can have instances with same name whereby overloading can be achieved.
